(19) United States
(12) Patent Application Publication
(10) Pub. No.: US 2026/0226302 A1
(43) Pub. Date: Aug. 6, 2026

(54) INK JET RECORDING METHOD AND INK JET RECORDING APPARATUS

(71) Applicant: CANON KABUSHIKI KAISHA, Tokyo (JP)

(72) Inventors: KAZUKI KIMURA, Kanagawa (JP); KOUHEI NAKAGAWA, Tokyo (JP); SHOICHI TAKEDA, Kanagawa (JP)

(21) Appl. No.: 19/530,596

(22) Filed: Feb. 5, 2026

(30) Foreign Application Priority Data
Feb. 6, 2025 (JP) 2025-018613
Jan. 21, 2026 (JP) 2026-008334

(51) Int. Cl. C09D 11/38; B41J 2/175

(52) U.S. Cl. CPC C09D 11/38; B41J 2/17513

(57) ABSTRACT

Provided is an ink jet recording method using an ink jet recording apparatus, which includes aqueous ink, an ink storage portion and a recording head having an ejection orifice surface, and is free of a suction mechanism configured to suck the aqueous ink in the recording head through an ejection orifice. The inner size X (mm) of the ink storage portion in an X-axis direction, the inner size Y (mm) thereof in a Y-axis direction and the inner size Z (mm) thereof in a Z-axis direction satisfy the relationships of the following formulae (1) and (2). The aqueous ink contains a pigment and a water-soluble organic solvent, and the average relative dielectric constant of the water-soluble organic solvent is 25.0 or more.

$$2.4 X \leq Y \leq 4. X \qquad ( 1 )$$

$$1. X < Z \leq 3. X \qquad ( 2 )$$

### BACKGROUND

### Field of the Technology

The present disclosure relates to an ink jet recording method and an ink jet recording apparatus.

### Description of the Related Art

In recent years, there has been an increasing demand for an ink jet recording apparatus for household use along with an increase of remote work at home and the like. For household use, the ink jet recording apparatus has been desired to be further downsized. To downsize the ink jet recording apparatus, the downsizing of a recording head, an ink storage portion and a mechanism for recovering the ejection state of the recording head is indispensable. Further, in the case of an ink jet recording apparatus for business use such as remote work at home, pigment ink containing a pigment as a coloring material has come to be used from the viewpoints of character quality and image fastness at the time of the recording of a document on a recording medium such as plain paper. In addition, to meet the demand for downsizing, for example, an ink jet recording apparatus mounted with a downsized recording unit (ink cartridge) in which a recording head and an ink storage portion are integrated has been proposed (Japanese Patent Laid-Open No. 2008-142935).

In addition, in the ink jet recording apparatus, when the vicinity of an ejection orifice of the recording head is clogged with ink or the like, or when the ink thickens in a flow path owing to the evaporation of its liquid components, the normal ejection of the ink may become difficult. To recover the ink ejection performance of the recording head, the following suction operation is sometimes performed: ink is forcibly discharged from the recording head by operating a suction pump connected to a suction cap under a state in which the suction cap is brought into abutment with an ejection orifice surface to generate a negative pressure in the suction cap. However, when the suction operation is performed, it has been required to provide the recording apparatus with a suction mechanism including suction members, such as a suction cap and a suction pump each having a certain size. Accordingly, a space for installing those suction members is required, and hence the recording apparatus has tended to increase in size. To cope with such problem, there has been proposed an ink jet recording apparatus whose recording apparatus main body is downsized by omitting a suction cap and a suction pump (Japanese Patent Laid-Open No. 2016-124229).

### SUMMARY

The inventors have conducted various investigations for the purpose of securing the ink storage amount of an ink storage portion and downsizing a recording apparatus main body. Specifically, the inventors have prepared the following recording apparatus with reference to the descriptions of Japanese Patent Laid-Open No. 2008-142935 and Japanese Patent Laid-Open No. 2016-124229: the recording apparatus includes a recording head having an ejection orifice surface on which an ejection orifice for ejecting an aqueous ink containing a pigment are formed, but does not include any suction mechanism for recovering the ink ejection performance of the recording head. The inventors have made an investigation by mounting the recording apparatus with such a recording unit in which an ink storage portion and a recording head are integrally formed as described below. When the direction of the reciprocating movement of the recording head (main scanning direction) was defined as an X-axis, a direction substantially perpendicular to the direction of the reciprocating movement (sub-scanning direction) was defined as a Y-axis, and the direction of gravity was defined as a Z-axis, the inner size X of the ink storage portion in the X-axis direction was made small, and the inner sizes Y and Z thereof in the Y-axis direction and the Z-axis direction were each made large. As a result, it was found that further downsizing of the recording apparatus main body was able to be achieved while the ink storage amount of the ink storage portion was secured.

However, as a result of a further investigation on the above-mentioned recording apparatus, the inventors have found that the following problem that has not been recognized so far arises: when the recording apparatus is left for a long time period under a state in which the aqueous ink is stored in the ink storage portion, density unevenness is liable to occur in a recorded image. In recent years, there has been a demand for an increase in capacity of the ink storage portion, and hence the time period for which the recording apparatus is left under a state in which the ink is stored in the ink storage portion tends to be longer. Accordingly, it has been strongly desired to solve the above-mentioned problem.

Accordingly, the present disclosure is directed to solving a problem that occurs when a recording apparatus, the apparatus including an ink storage portion in which an ink storage amount is sufficiently secured, but being free of a suction mechanism for sucking aqueous ink in a recording head through an ejection orifice, is used. That is, the present disclosure is directed to providing an ink jet recording method capable of recording, when such recording apparatus is used, an image in which density unevenness is unlikely to occur even after the recording apparatus has been left for a long time period under a state of storing the aqueous ink. The present disclosure is also directed to providing an ink jet recording apparatus to be used in the ink jet recording method.

That is, according to the present disclosure, there is provided an ink jet recording method including recording an image by applying aqueous ink ejected from an ejection orifice to a recording medium through use of an ink jet recording apparatus, the ink jet recording apparatus including: the aqueous ink; an ink storage portion configured to store the aqueous ink; and a recording head having an ejection orifice surface, which is attached to the ink storage portion and on which the ejection orifice configured to eject the aqueous ink supplied from the ink storage portion are formed, the ink jet recording apparatus being free of a suction mechanism configured to suck the aqueous ink in the recording head through the ejection orifice, wherein, when a direction of reciprocating movement of the recording head is defined as an X-axis direction, a direction substantially perpendicular to the direction of the reciprocating movement of the recording head is defined as a Y-axis direction, and a direction of gravity is defined as a Z-axis direction, an inner size X (mm) of the ink storage portion in the X-axis direction, an inner size Y (mm) thereof in the Y-axis direction and an inner size Z (mm) thereof in the Z-axis direction satisfy relationships of the following formulae (1) and (2), wherein the aqueous ink contains a pigment and a water-soluble organic solvent, and wherein an average relative dielectric constant of the water-soluble organic solvent is 25.0 or more.

$$2.4 X \leq Y \leq 4. X \qquad ( 1 )$$

$$1. X < Z \leq 3. X \qquad ( 2 )$$

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view for schematically illustrating the internal structure of an ink jet recording apparatus according to an embodiment of the present disclosure.

FIG. 2 is a perspective view for schematically illustrating an example of a recording unit.

FIG. 3A is a perspective view for schematically illustrating an example of the recording unit.

FIG. 3B is an exploded perspective view for schematically illustrating an example of the recording unit.

FIG. 4A is a top view for schematically illustrating an example of the recording unit in a state in which its lid is removed.

FIG. 4B is a front view for schematically illustrating an example of the recording unit.

FIG. 4C is a bottom view for schematically illustrating an example of the recording unit.

### DESCRIPTION OF THE EMBODIMENTS

The present disclosure is described in more detail below by way of exemplary embodiments. In the present disclosure, when a compound is a salt, the salt is present in a state of dissociating into ions in aqueous ink, but the expression “contains the salt” is used for convenience. In addition, aqueous ink for ink jet is sometimes simply described as “ink”. Physical property values are values at normal temperature (25° C.) unless otherwise stated. In addition, various numerical values are each calculated by defining the specific gravity of the ink as “1 g/mL” for convenience.

The inventors have made an investigation on the shape of an ink storage portion in a recording unit (ink cartridge) downsized by the integration of the ink storage portion and a recording head in order to meet the downsizing of an ink jet recording apparatus. As described above, the direction of the reciprocating movement of the recording head (main scanning direction) is defined as an X-axis, the direction substantially perpendicular to the direction of the reciprocating movement (sub-scanning direction) is defined as a Y-axis, and the direction of gravity is defined as a Z-axis. In order to downsize the recording apparatus while securing the ink storage amount of the ink storage portion, first, the apparatus is configured to include the ink storage portion adjusted as follows: its inner size X in the X-axis direction is made small, and its inner sizes Y and Z in the Y-axis direction and the Z-axis direction are each made large. Further, it is required to configure the apparatus so that the apparatus may be free of a suction mechanism including suction members each requiring a space for installation, such as a suction cap and a suction pump.

However, when the recording apparatus having the above-mentioned configuration is used, as described above, the following problem arises: density unevenness is liable to occur in a recorded image in the case where the recording apparatus is left for a long time period under a state in which ink is stored in the ink storage portion. The inventors have analyzed a reason for the foregoing in detail, and as a result, have found that the above-mentioned problem occurs for the following reasons.

The inner size X of the ink storage portion in the X-axis direction, the inner size Y thereof in the Y-axis direction and the inner size Z thereof in the Z-axis direction correspond to the width, depth and height of the ink storage portion, respectively. When a recording unit having a large height Z with respect to its width X is mounted on the recording apparatus and left for a long time period, the concentration per unit ink-volume of a pigment sedimented at the bottom of the ink storage portion becomes relatively larger than that in the case where the height Z is small. Thus, the pigment aggregates to thicken the ink. In addition, a region that is distant from an ejection orifice may be present at the bottom of the ink storage portion having a large depth Y with respect to the width X. The ink thickened in the region has lowered fluidity and is liable to stagnate on the spot without flowing to the ejection orifice. In the case of a recording apparatus that is free of a suction mechanism serving as a recovery unit, a negative pressure applied to the ink storage portion during ink ejection is small, and hence the stagnant ink cannot be moved to the ejection orifice. Thus, the ink remains in a stagnation portion. As a result, the ink concentrated in the stagnation portion continues to be supplied slowly to the ejection orifice without mixing with non-concentrated ink. Thus, a difference in pigment concentration may be liable to occur in the array direction of an ejection orifice array to cause the density unevenness in the image.

The inventors have made a further investigation to solve the above-mentioned problem that occurs when an ink jet recording apparatus, the apparatus including an ink storage portion in which an ink storage amount is sufficiently secured, but being free of a suction mechanism for sucking aqueous ink in a recording head through an ejection orifice, is used. As a result, the inventors have found that the adoption of a configuration satisfying the following requirements (i) to (iii) enables the recording of an image in which density unevenness is unlikely to occur even after the recording apparatus has been left for a long time period under a state of storing ink. Thus, the inventors have reached the present disclosure.
(i) The inner size X (mm) of the ink storage portion in the X-axis direction, the inner size Y (mm) thereof in the Y-axis direction and the inner size Z (mm) thereof in the Z-axis direction satisfy the relationships of the following formulae (1) and (2).

$$2.4 X \leq Y \leq 4. X \qquad ( 1 )$$

$$1. X < Z \leq 3. X \qquad ( 2 )$$

(ii) The aqueous ink contains a pigment and a water-soluble organic solvent.
(iii) The average relative dielectric constant of the water-soluble organic solvent is 25.0 or more.

When the average relative dielectric constant of the water-soluble organic solvent in the ink is set to 25.0 or more, the stability of charge contributing to the dispersion of the pigment is increased, and the dispersion state of the pigment can be kept stable even under a state in which the concentration of the pigment is increased. Probably as a result of the foregoing, even when the pigment concentration of the ink at the bottom of the ink storage portion increases, the aggregation of the pigment is suppressed, and hence a reduction in fluidity of the ink can be suppressed and the occurrence of the density unevenness in the image can be suppressed. Thus, even in a recording apparatus including an ink storage portion in which the above-mentioned requirement (i) is satisfied and hence the ink storage amount is sufficiently secured, the dispersion state of the pigment can be kept stable, and hence the aggregation thereof is effectively reduced and the thickening of the ink in the stagnation portion can be suppressed. Accordingly, even without a suction mechanism, the discharge of the ink in the stagnation portion can be promoted, and hence the density unevenness of the image can be suppressed.

When the height Z of the ink storage portion is set to be more than 1.0 times to 3.0 times or less as large as the width X, an increase in pigment concentration at the bottom of the ink storage portion can be suppressed, and hence the density unevenness of the image can be suppressed. In addition, when the depth Y of the ink storage portion is set to be 2.4 times or more to 4.0 times or less as large as the width X, a stagnation area at the bottom of the ink storage portion can be reduced, and hence the density unevenness of the image can be suppressed. When the height Z of the ink storage portion is more than 3.0 times as large as the width X, the pigment concentration is liable to increase remarkably at the bottom of the ink storage portion. Thus, the ink in the stagnation portion thickens to be reduced in fluidity, and hence it becomes difficult to suppress the density unevenness of the image. In addition, when the depth Y of the ink storage portion is more than 4.0 times as large as the width X, the stagnation area at the bottom of the ink storage portion expands to make it difficult to suppress the density unevenness of the image. When the height Z of the ink storage portion is 1.0 times or less as large as the width X, it may be difficult to increase the ink storage amount. In addition, when the depth Y of the ink storage portion is less than 2.4 times as large as the width X, it may be difficult to increase the ink storage amount.

### <Ink Jet Recording Method and Ink Jet Recording Apparatus>

An ink jet recording method of the present disclosure is a recording method using an ink jet recording apparatus, which includes ink, an ink storage portion configured to store the ink and a recording head, and is free of a suction mechanism configured to suck the ink in the recording head through an ejection orifice. The recording head has an ejection orifice surface, which is attached to the ink storage portion and on which the ejection orifice configured to eject the ink supplied from the ink storage portion are formed. The ink jet recording method of the present disclosure includes a step of recording an image by applying the ink ejected from the ejection orifice to a recording medium. The direction of the reciprocating movement of the recording head is defined as an X-axis direction, a direction substantially perpendicular to the direction of the reciprocating movement is defined as a Y-axis direction, and the direction of gravity is defined as a Z-axis direction. In this case, the inner size X (mm) of the ink storage portion in the X-axis direction, the inner size Y (mm) thereof in the Y-axis direction and the inner size Z (mm) thereof in the Z-axis direction satisfy the relationships of the following formulae (1) and (2). In addition, the ink contains a pigment and a water-soluble organic solvent, and the average relative dielectric constant of the water-soluble organic solvent is 25.0 or more.

$$2.4 X \leq Y \leq 4. X \qquad ( 1 )$$

$$1. X < Z \leq 3. X \qquad ( 2 )$$

In addition, an ink jet recording apparatus of the present disclosure is an apparatus, which includes ink, an ink storage portion configured to store the ink and a recording head, and is free of a suction mechanism configured to suck the ink in the recording head through an ejection orifice. The recording head has an ejection orifice surface, which is attached to the ink storage portion and on which the ejection orifice configured to eject the ink supplied from the ink storage portion are formed. The inner size X (mm) of the ink storage portion in the X-axis direction, the inner size Y (mm) thereof in the Y-axis direction and the inner size Z (mm) thereof in the Z-axis direction satisfy the relationships of the following formulae (1) and (2). In addition, the ink contains a pigment and a water-soluble organic solvent, and the average relative dielectric constant of the water-soluble organic solvent is 25.0 or more.

$$2.4 X \leq Y \leq 4. X \qquad ( 1 )$$

$$1. X < Z \leq 3. X \qquad ( 2 )$$

### (Aqueous Ink)

The ink jet recording method of the present disclosure uses ink jet ink containing the pigment and the water-soluble organic solvent, and includes the step of recording an image by applying the ink ejected from the ejection orifice to the recording medium. The ink is not required to be so-called “curable ink.” Accordingly, the ink may be free of a compound such as a polymerizable monomer capable of being polymerized by the application of external energy. In addition, the ink is not required to react with any other ink or reaction liquid. Accordingly, the ink may be free of a reaction agent, such as a cationic resin, a polyvalent metal salt or an organic acid, and the ink is not required to be used in combination with ink or a reaction liquid containing a reaction agent.

### [Pigment]

Inorganic pigments, such as carbon black, calcium carbonate and titanium oxide, and organic pigments, such as azo pigments, phthalocyanine pigments, quinacridone pigments, isoindolinone pigments, imidazolone pigments, diketopyrrolopyrrole pigments and dioxazine pigments, may each be used as the pigment. Of those, organic pigments and carbon black are preferably used, and carbon black is more preferably used.

Any one of carbon blacks, such as furnace black, lamp black, acetylene black and channel black, may be used as the carbon black.

The DBP oil absorption of the carbon black is preferably 50 mL/100 g or more to 200 mL/100 g or less. In particular, the DBP oil absorption is more preferably 120 mL/100 g or more to 170 mL/100 g or less, particularly preferably 120 mL/100 g or more to 150 mL/100 g or less. The DBP oil absorption of the carbon black may be measured by a method in conformity with JIS K6221 or ASTM D-2414. This method includes: dropping dibutyl phthalate into 100 g of the carbon black under stirring; and measuring the addition amount of dibutyl phthalate at the time point when torque becomes maximum.

The specific surface area of the carbon black based on a BET method is preferably 100 m²/g or more to 600 m²/g or less. The specific surface area of the carbon black based on the BET method may be measured by a method in conformity with, for example, JIS K6217 or ASTM D-6556. Those methods are each a method including: immersing the carbon black that has been deaerated in liquid nitrogen; and measuring the amount of nitrogen adsorbing to the surface of the particle of the carbon black when equilibrium is reached.

The primary particle diameter of the carbon black is preferably 10 nm or more to 40 nm or less. The carbon black is typically present under a state in which a plurality of primary particles are three-dimensionally connected to each other like a bunch of grapes. The primary particle diameter means the particle diameter of the carbon black (primary particle) serving as the minimum unit for forming one particle. The primary particle diameter of the carbon black may be determined as an arithmetic average obtained by: observing about 100 particles of the carbon black each serving as the minimum unit for forming the particle with a transmission or scanning electron microscope; and measuring their particle diameters, followed by their averaging.

Examples of a dispersion system for the pigment may include a resin-dispersed pigment using a resin (resin dispersant) as a dispersant and a self-dispersible pigment having a hydrophilic group bonded to its particle surface. In addition, for example, a resin-bonded pigment having a resin-containing organic group chemically bonded to its particle surface or a microcapsule pigment whose particle surface is coated with a resin or the like may be used. Of those, a self-dispersible pigment is preferably used. In the case of ink containing a resin-dispersed pigment, when the pigment sediments at the bottom of the ink storage portion, the ink may be liable to thicken owing to the entanglement of the polymer chains of the resin dispersant.

A pigment having an anionic group, such as a carboxylic acid group, a sulfonic acid group or a phosphonic acid group, bonded to its particle surface directly or via another atomic group (—R—) may be used as the self-dispersible pigment. The anionic group is preferably a carboxylic acid group. The anionic group may be any one of an acid type or a salt type. When the group is a salt type, the group may be in any one of a state in which part of the group dissociates or a state in which the entirety thereof dissociates. When the anionic group is a salt type, examples of a cation serving as a counterion may include an alkali metal cation, ammonium and an organic ammonium. Of those, an alkali metal salt type, such as sodium or potassium, or an ammonium salt type is preferable. Specific examples of another atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

The anionic group amount of the self-dispersible pigment may be measured by colloidal titration utilizing a potential difference. A larger value of the anionic group amount means a larger ionic group amount and a smaller value thereof means a smaller ionic group amount. The anionic group amount of the self-dispersible pigment is an amount per 1 g of the solid content of the self-dispersible pigment. In Examples to be described later, the anionic group amount of the self-dispersible pigment in a pigment dispersion liquid was measured with an automatic potentiometric titrator (product name: “AT-510”, manufactured by Kyoto Electronics Manufacturing Co., Ltd.) mounted with a streaming potential titration unit (PCD-500) by colloidal titration utilizing a potential difference. Methyl glycol chitosan was used as a titration reagent. The anionic group amount may be measured through use of the self-dispersible pigment extracted from the ink by an appropriate method.

The anionic group amount of the self-dispersible pigment is preferably 0.08 mmol/g or more to 0.30 mmol/g or less. When the anionic group amount is less than 0.08 mmol/g, the dispersion stability of the pigment is liable to reduce. As a result, when the concentration of the pigment increases along with the sedimentation of the pigment or the evaporation of its liquid components, the ink may be liable to thicken. Meanwhile, when the anionic group amount is more than 0.30 mmol/g, the amount of a hydrophobic moiety on the particle surface of the pigment reduces. In such case, when the pigment concentration increases owing to the evaporation of the liquid components in the vicinity of the ejection port or the sedimentation of the pigment in the vicinity of an ejection orifice, the ionicity of the particle surface of the pigment is lost. Thus, the solvation of the water-soluble organic solvent to the hydrophobic moiety on the particle surface of the pigment hardly occurs, and hence the pigment is liable to aggregate or thicken drastically in some cases. Accordingly, when the thickened ink is supplied to the ejection orifice, its ejection speed reduces in the vicinity of the ejection orifice, and hence the density unevenness of an image is liable to occur in some cases. In any of the cases, when the anionic group amount deviates from the ranges, a suppressing effect on the occurrence of the density unevenness may reduce.

The average particle diameter of the pigment is preferably 40 nm or more to 220 nm or less. When the average particle diameter is less than 40 nm, the area of the particle surface of the pigment per unit mass increases to strengthen the cohesive force thereof, and hence the thickening of the ink due to the sedimentation of the pigment or the evaporation of its liquid components is liable to occur remarkably. Thus, the suppressing effect on the occurrence of the density unevenness may reduce. Meanwhile, when the average particle diameter is more than 220 nm, the sedimentation speed of the pigment in the ink increases to increase the pigment concentration in the ink at the bottom of the ink storage portion. Thus, the ink is liable to thicken and hence the suppressing effect on the occurrence of the density unevenness reduces in some cases. The average particle diameter of the pigment refers to the particle diameter of the pigment as a usually existing form. The term “average particle diameter” as used herein means a cumulative 50% particle diameter (D50 (nm)) in a volume-based particle diameter distribution measured with a dynamic light scattering type particle size distribution measuring apparatus or the like.

The content (% by mass) of the pigment in the ink is preferably 0.10% by mass or more to 15.00% by mass or less, more preferably 1.00% by mass or more to 10.00% by mass or less with respect to the total mass of the ink.

### [Aqueous Medium]

The ink is aqueous ink containing an aqueous medium, which is a mixed solvent of water and a water-soluble organic solvent. Deionized water (ion-exchange water) is preferably used as the water. The content (% by mass) of the water in the ink is preferably 10.00% by mass or more to 95.00% by mass or less, more preferably 50.00% by mass or more to 95.00% by mass or less with respect to the total mass of the ink. The content (% by mass) of the water-soluble organic solvent in the ink is preferably 3.00% by mass or more to 50.00% by mass or less, more preferably 3.00% by mass or more to 40.00% by mass or less with respect to the total mass of the ink.

The ink contains the water-soluble organic solvent. In addition, the average relative dielectric constant of the water-soluble organic solvent at 25° C. is 25.0 or more, preferably 28.0 or more, more preferably 30.0 or more, and is preferably 40.0 or less.

The relative dielectric constant of the water-soluble organic solvent or the water may be measured with a dielectric constant meter (e.g., product name: “BI-870” (manufactured by Brookhaven Instruments Corporation)) under the condition of a frequency of 10 kHz. The relative dielectric constant of the water-soluble organic solvent that is a solid at a temperature of 25° C. is a value calculated from the following equation (X) after the measurement of the relative dielectric constant of a 50% by mass aqueous solution thereof. Although the term “water-soluble organic solvent” typically means a liquid, in the present disclosure, a solvent that is a solid at 25° C. (normal temperature) is also included in the category of the water-soluble organic solvent.

$${ε}_{sol} = 2 {ε}_{50 \%} - {ε}_{water} \qquad ( X )$$

εₛₒₗ: relative dielectric constant of the water-soluble organic solvent that is a solid at 25° C.
ε_{50%}: relative dielectric constant of a 50% by mass aqueous solution of the water-soluble organic solvent that is a solid at 25° C.
ε_{water}: relative dielectric constant of water

Specific examples of the water-soluble organic solvent that is a solid at 25° C., the solvent being widely used in aqueous ink, may include 1,6-hexanediol, trimethylolpropane, ethylene urea, urea and polyethylene glycol having a number-average molecular weight of 1,000.

The reason why the relative dielectric constant of the water-soluble organic solvent that is a solid at 25° C. is calculated from the relative dielectric constant of the 50% by mass aqueous solution thereof is as described below. Some of the water-soluble organic solvents that are solids at 25° C. can be components of aqueous ink but aqueous solutions thereof each having a high concentration exceeding 50% by mass are difficult to prepare. Meanwhile, in an aqueous solution having a concentration as low as 10% by mass or less, the relative dielectric constant of water becomes dominant, and hence it is difficult to obtain a probable (effective) value of the relative dielectric constant of the water-soluble organic solvent. In view of the foregoing, the inventors have made an investigation, and as a result, have found that for most of the water-soluble organic solvents for use in ink that are solids at 25° C., aqueous solutions to be measured can be prepared, and their calculated relative dielectric constants are consistent with the effect of the present disclosure. For the above-mentioned reasons, in the present disclosure, the relative dielectric constant of the water-soluble organic solvent that is a solid at 25° C., the relative dielectric constant being calculated from the relative dielectric constant of the 50% by mass aqueous solution thereof, is used. When a water-soluble organic solvent is a solid at 25° C., but its solubility in water is low and hence a 50% by mass aqueous solution thereof cannot be prepared, the value of a relative dielectric constant calculated in accordance with the case of the calculation of εₛₒₗ described above through utilization of an aqueous solution having a saturated concentration is used for convenience.

The average relative dielectric constant means a value obtained by: multiplying a relative dielectric constant inherent to a water-soluble organic solvent by the ratio (% by mass) of the water-soluble organic solvent in the total amount of the water-soluble organic solvents in the ink; calculating the value for each water-soluble organic solvent; and integrating the values. When only one kind of water-soluble organic solvent is incorporated into the ink, the relative dielectric constant of the water-soluble organic solvent is the “average relative dielectric constant.”

For example, in the case of “Ink 1” prepared in Examples to be described later, the composition of its water-soluble organic solvents (total: 20.0 parts by mass) is as described below. The numerical values in parentheses are the relative dielectric constants of the respective water-soluble organic solvents.
Glycerin (42.3): 10.00 parts by mass
Triethylene glycol (22.7): 10.00 parts by mass

The average relative dielectric constant of the water-soluble organic solvents in the ink may be calculated as described below.

$$Average relative dielectric constant = 42.3 \times 10.00 / 20.00 + 22.7 \times 10.00 / 20.00 = 32.5$$

The relative dielectric constants of water-soluble organic solvents widely used in aqueous ink for ink jet are described below: urea (110.3), ethyl isopropyl sulfone (59.0), ethylene urea (49.7), dimethyl sulfoxide (48.9), glycerin (42.3), γ-butyrolactone (41.9), ethylene glycol (40.4), 1-(2-hydroxyethyl)-2-pyrrolidone (37.6), trimethylolpropane (33.7), methanol (33.1), N-methyl-2-pyrrolidone (32.0), triethanolamine (31.9), diethylene glycol (31.7), 1,4-butanediol (31.1), 1,3-butanediol (30.0), 3-methyl sulfolane (29.0), 1,2-propanediol (28.8), 1,2,6-hexanetriol (28.5), 2-methyl-1,3-propanediol (28.3), 2-pyrrolidone (28.0), 1,5-pentanediol (27.0), 3-methyl-1,3-butanediol (24.0), 3-methyl-1,5-pentanediol (23.9), ethanol (23.8), 1-(hydroxymethyl)-5,5-dimethylhydantoin (23.7), triethylene glycol (22.7), tetraethylene glycol (20.8), polyethylene glycol having a number-average molecular weight of 200 (18.9), 2-ethyl-1,3-hexanediol (18.5), isopropanol (18.3), 1,2-hexanediol (14.8), n-propanol (12.0), polyethylene glycol having a number-average molecular weight of 600 (11.4), triethylene glycol monobutyl ether (9.8), tetraethylene glycol monobutyl ether (9.4), tripropylene glycol monomethyl ether (8.5), 1,6-hexanediol (7.1), and polyethylene glycol having a number-average molecular weight of 1,000 (4.6).

In the ink, the content (% by mass) of a water-soluble organic solvent having a relative dielectric constant of 25.0 or more (first water-soluble organic solvent) is preferably 1.0 times or more to 10.0 times or less, more preferably 1.5 times or more to 5.0 times or less in terms of mass ratio with respect to the content (% by mass) of the pigment. In the ink, the ratio of the content (% by mass) of the water-soluble organic solvent having a relative dielectric constant of 25.0 or more (first water-soluble organic solvent) to the total content (% by mass) of the water-soluble organic solvents is preferably 35.0% by mass or more. When the ratio of the content of the first water-soluble organic solvent to the total content of the water-soluble organic solvents is 35.0% by mass or more, the water-soluble organic solvent having a high relative dielectric constant exists at a high concentration. Thus, the dispersion stability of the pigment is further improved, and hence a reduction in fluidity of the ink at the bottom of the ink storage portion can be further suppressed. The above-mentioned ratio is preferably 90.0% by mass or less, more preferably 80.0% by mass or less.

In addition, in the ink, the ratio of the content (% by mass) of a water-soluble organic solvent having a relative dielectric constant of 35.0 or more (second water-soluble organic solvent) to the total content (% by mass) of the water-soluble organic solvents is preferably 35.0% by mass or more. When the ratio of the content of the second water-soluble organic solvent to the total content of the water-soluble organic solvents is 35.0% by mass or more, the water-soluble organic solvent having a higher relative dielectric constant exists at a high concentration. Thus, the dispersion stability of the pigment is further improved, and hence a reduction in fluidity of the ink at the bottom of the ink storage portion can be further suppressed. The above-mentioned ratio is preferably 90.0% by mass or less, more preferably 80.0% by mass or less.

The characteristics of each of the water-soluble organic solvents may be verified in accordance with a method described below. The kind of the water-soluble organic solvent may be identified by: diluting an appropriate amount of the ink with methanol; and subjecting the ink to qualitative analysis by gas chromatography/mass spectrometry (GC/MS). Further, the content of the water-soluble organic solvent may be identified by an absolute calibration curve method using a standard solution of the analysis target component. Then, the average relative dielectric constant of the water-soluble organic solvents in the ink may be determined from the kind and content of the water-soluble organic solvent thus identified.

### [Surfactant]

The ink may further contain a surfactant. Examples of the kind of the surfactant may include an anionic surfactant, a nonionic surfactant, a cationic surfactant and an amphoteric surfactant. The content (% by mass) of the surfactant in the ink is preferably 0.10% by mass or more to 5.00% by mass or less based on the total mass of the ink.

The surfactant is preferably a nonionic surfactant. Surfactants having various structures, such as hydrocarbon-based, silicone-based and fluorine-based surfactants, may each be used as the nonionic surfactant. In particular, the nonionic surfactant in the ink preferably includes a compound represented by the following general formula (A) (acetylene glycol-based surfactant).

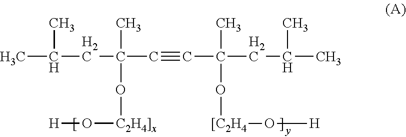

In the general formula (A), “x” and “y” each independently represent an integer of 0 or more.

When ink containing a surfactant is used, at the time of the flow of the ink stagnant at the bottom of the ink storage portion toward the ejection orifice, the surfactant is oriented toward its interfaces with the inner wall of the ink storage portion and an ink absorbent. Thus, the wettability of the ink with respect to each of the inner wall of the ink storage portion and the ink absorbent is improved, and hence a reduction in fluidity of the ink toward the ejection orifice due to its thickening is suppressed. However, some surfactants are particularly liable to adsorb to the particle surface of the pigment. When such surfactant is used, the amount of the surfactant oriented toward the interfaces with the inner wall of the ink storage portion and the ink absorbent reduces, and hence a reduction in fluidity of the ink is not sufficiently suppressed in some cases.

In contrast, the state of the adsorption of the acetylene glycol-based surfactant, which is a compound represented by the general formula (A), to the particle surface of the pigment tends to be unstable, and the speed at which the surfactant is oriented toward each of the interfaces is high. Accordingly, the surfactant is quickly oriented toward the interfaces with the inner wall of the ink storage portion and the ink absorbent. Thus, it is conceivable that a reduction in fluidity of the ink toward the ejection orifice can be more effectively suppressed. In the general formula (A), the sum of “x” and “y” (x+y) is preferably 0 or more to 30 or less, more preferably 0 or more to 12 or less. In the general formula (A), “x” and “y” are each preferably 0 or more to 20 or less.

The HLB value of the nonionic surfactant is preferably 14 or less, more preferably 11 or less, particularly preferably 0. The term “HLB value” as used herein refers to a value determined by a Griffin method. The HLB value determined by the Griffin method may be calculated in accordance with the following formula (9). A hydrophilic group in the formula (9) is, for example, an ethylene oxide group. The HLB value determined by the Griffin method is a physical property value indicating the degree of hydrophilicity or lipophilicity of the surfactant, and takes a value of from 0 to 20. Among compounds each showing surface activity (nonionic surfactants), a surfactant having a small HLB value tends to have a compact structure and its diffusion speed in the ink is high. Of such surfactants, a nonionic surfactant having an HLB value of 14 or less is oriented more quickly toward its interfaces with the inner wall of the ink storage portion and the ink absorbent, and hence a reduction in fluidity of the ink can be more effectively suppressed.

$$( 9 )$$

$$HLB value = 20 \times molecular weight of hydrophilic group of surfactant / molecular weight of surfactant$$

The nonionic surfactant preferably further includes a compound represented by the following general formula (B) (ethylene oxide adduct of glycerin). The compound represented by the general formula (B) is a compound having a structure in which an ethylene oxide group is added to glycerin. The compound has a small hydrophobic moiety, and hence even when the pigment sediments at the bottom of the ink storage portion to increase the pigment concentration in the ink, the compound may hardly adsorb to the particle surface of the pigment. Accordingly, when the compound represented by the general formula (B) is used, the wettability of the ink stagnant at the bottom of the ink storage portion with respect to each of the inner wall of the ink storage portion and the ink absorbent is maintained, and hence the fluidity of the ink toward the ejection orifice can be maintained.

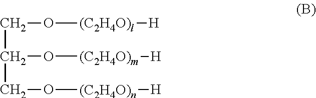

In the general formula (B), “l”, “m” and “n” each independently represent an integer of 0 or more, and l+m+n is 1 or more.

The content (% by mass) of the compound represented by the general formula (B) in the ink is preferably 0.10% by mass or more to 5.00% by mass or less, more preferably 0.10% by mass or more to 2.00% by mass or less with respect to the total mass of the ink. In the general formula (B), the sum of “l”, “m” and “n” (l+m+n) is 1 or more, preferably 8 or more. In a compound in which the sum of “l”, “m” and “n” is 8 or more, the ratio of its hydrophobic moiety is smaller, and hence its adsorption to the hydrophobic moiety of the pigment is more effectively suppressed. l+m+n is preferably 50 or less, more preferably 30 or less. In the general formula (B), “l”, “m” and “n” are each preferably 0 or more to 20 or less.

### [Other Components]

Besides the above-mentioned components, as required, the ink may also contain various additives, such as any other surfactant, a resin, a pH adjuster, an antifoaming agent, a rust preventive, a preservative, a fungicide, an antioxidant, a reduction inhibitor and an evaporation accelerator. The content of such additive in the ink is generally quite small and the influence thereof on the effect of the present disclosure is also small. Accordingly, in the present disclosure, such additive is not included in the “water-soluble organic solvent” and is not subject to the calculation of a relative dielectric constant. When any other surfactant is used, it is preferable that the action of the surfactant represented by the general formula (A) or the surfactant represented by the general formula (B) to be used as required not to be impaired. Accordingly, the ratio (% by mass) of the content of the other surfactant to the total content of the surfactants in the ink is preferably 5.0% by mass or less, more preferably 1.0% by mass or less, and the ratio may be 0.0% by mass.

### [Physical Properties of Ink]

The viscosity no of the ink at 25° C. is preferably 1.7 mPa·s or more to 4.0 mPa·s or less. When the viscosity no of the ink is less than 1.7 mPa·s, the sedimentation speed of the pigment is so fast that the pigment concentration of the ink at the bottom of the ink storage portion is liable to increase. Accordingly, the fluidity of the ink may reduce to easily cause the stagnation thereof. Meanwhile, when the viscosity no of the ink is more than 4.0 mPa·s, the viscosity of the ink at the bottom of the ink storage portion is liable to become higher, and hence the fluidity of the ink reduces to easily cause the stagnation thereof in some cases. In addition, the viscosity η₄₀ of evaporated ink, which is obtained by evaporating 40% by mass of the ink, at 25° C. is preferably 2.0 mPa·s or more to 50.0 mPa·s or less. The viscosity η₄₀ of the evaporated ink may be adjusted by the kinds and contents of the pigment, a resin (a water-soluble resin or resin particles), the water-soluble organic solvent and the like. In particular, a water-soluble resin or a water-soluble organic solvent having a vapor pressure lower than that of water is effective in increasing the viscosity of the evaporated ink because the resin or the solvent easily increases the viscosity of the evaporated ink even when used in a small amount.

The viscosity η₀ (mPa·s) of the ink at 25° C. and the viscosity η₄₀ (mPa·s) of the evaporated ink, which is obtained by evaporating 40% by mass of the ink, at 25° C. preferably satisfy the relationship of the following formula (3). The ink, which is stagnant at the bottom of the ink storage portion and hence has an increased pigment concentration, is further concentrated by the evaporation of its liquid components from the ejection orifice during a period from its flow toward the ejection orifice to its ejection. When the viscosity η₄₀ of the evaporated ink is more than 7.1 times as high as the viscosity η₀ of the ink, the ejection speed of the ink thickened by the increase in pigment concentration reduces, and hence a suppressing effect on the density unevenness of an image reduces in some cases. In contrast, when ink whose η₀ and η₄₀ satisfy the relationship of the following formula (3) is used, the thickening of the ink due to the evaporation of its liquid components in the vicinity of the ejection orifice can be more effectively reduced, and hence the occurrence of the density unevenness of the image can be more effectively suppressed. In the evaporated ink in which 40% by mass of the ink is evaporated, the distance between pigment particles decreases as the pigment concentration increases, and the dispersion state of the pigment particle becomes unstable due to the increased concentration of water-soluble organic solvent, which have a lower vapor pressure than water and, as a result, the ink thickens. In other words, the viscosity η₄₀ (mPa·s) of the evaporated ink has a relation with the fluidity of the ink when the recording apparatus has been left unused for a long time period and the pigment has settled at the bottom of the ink storage portion, and it can be regarded as a property representing the behavior of the ink at the bottom of the ink storage portion. On the other hand, according to the investigation, the evaporated ink with an evaporation rate of 30% by mass exhibits only a small degree of thickening, while the evaporated ink with an evaporation rate of 50% by mass thickens excessively. Therefore, in either case, the correlation with the viscosity-increase behavior upon evaporation, which depends on the ink composition, was small, making it difficult to appropriately represent the characteristics of the ink. The viscosity of the ink may be measured with a rotational viscometer or the like.

$${η}_{40} \leq 7.1 {η}_{0} \qquad ( 3 )$$

The ink is aqueous ink to be applied to an ink jet system. Accordingly, from the viewpoint of reliability, it is preferable that the physical property values of the ink be appropriately controlled. Specifically, the surface tension γ of the ink at 25° C. is preferably 25 mN/m or more to 45 mN/m or less. In addition, the pH of the ink at 25° C. is preferably 7.0 or more to 9.5 or less, more preferably 8.0 or more to 9.5 or less.

### (Ink Jet Recording Apparatus)

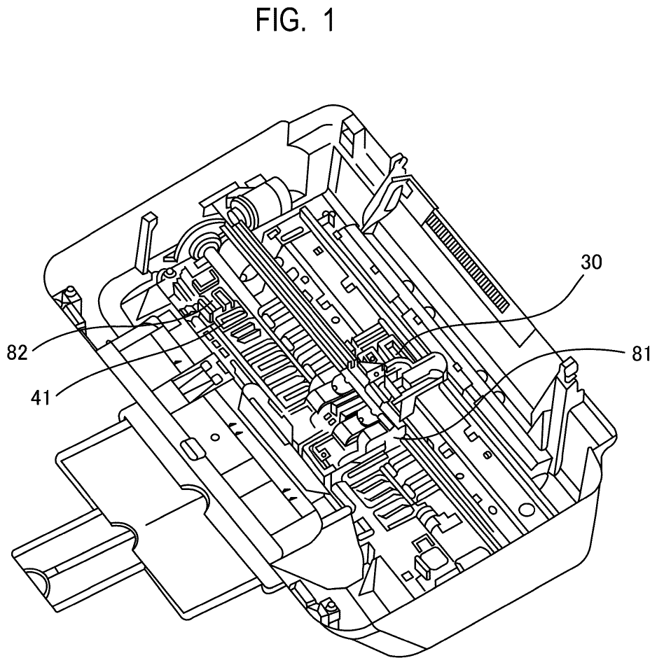

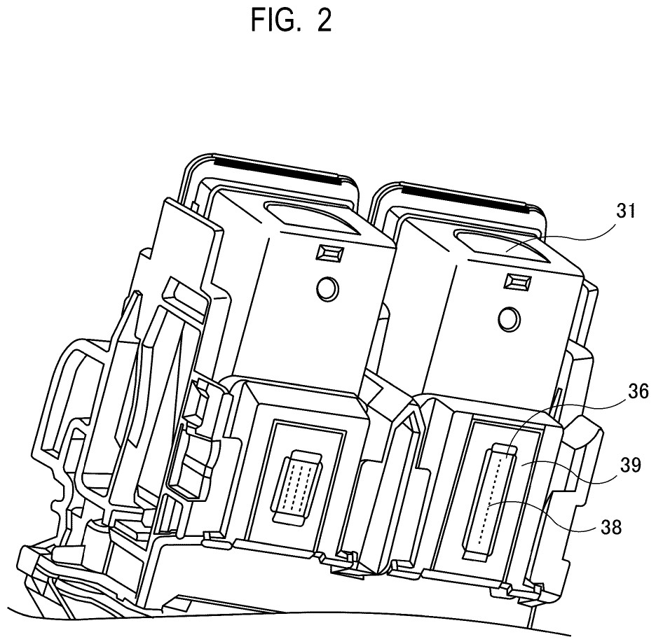

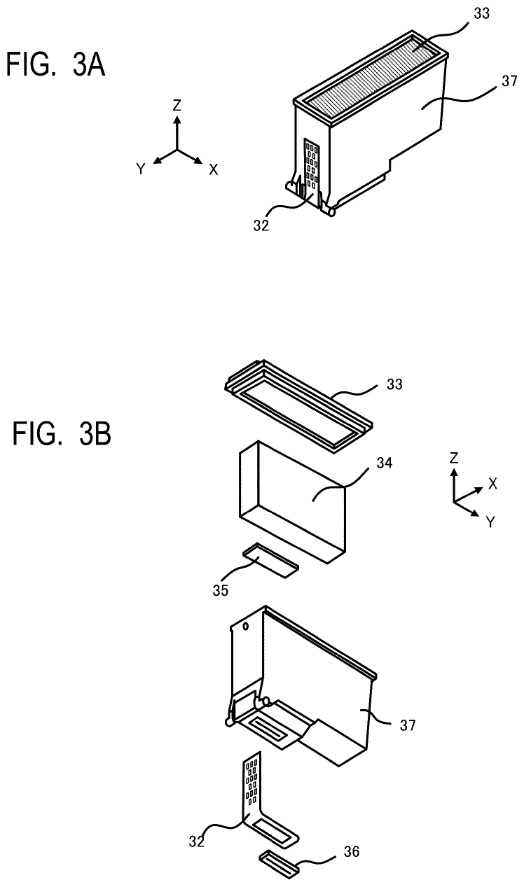

FIG. 1 is a perspective view for schematically illustrating the internal structure of the ink jet recording apparatus according to an embodiment of the present disclosure. As illustrated in FIG. 1, a recording unit 30 in which a recording head and an ink storage portion are integrally formed is configured to be mountable on a carriage (support member) 81. The recording unit 30 is arranged on the carriage by being connected to a joint arranged in the upper portion of the carriage 81. The ink jet recording apparatus of the embodiment illustrated in FIG. 1 is a serial scan type recording apparatus, and the carriage 81 is guided by a guide shaft so as to be reciprocally movable in its main scanning direction. The carriage 81 is reciprocated in the main scanning direction (X direction) by a driving force transmission mechanism formed of, for example, a carriage motor and a belt transmitting the driving force of the carriage motor. A recording medium is conveyed by a conveying roller in a sub-scanning direction (Y direction) substantially perpendicular to the main scanning direction (X direction) of the carriage 81. The phrase “substantially perpendicular” includes not only a case in which the directions are strictly perpendicular to each other but also a case in which the directions can be regarded as being substantially perpendicular to each other (case with an error of about ±5°). The ink jet recording apparatus repeatedly performs a recording operation of ejecting ink toward the recording region of the recording medium on a platen while moving a recording head 36 (FIG. 2 and FIG. 3B) in the main scanning direction, and a conveying operation of conveying the recording medium in the sub-scanning direction by a distance corresponding to its recording width. Thus, an image can be recorded on the recording medium.

FIG. 3A and FIG. 3B are each a view for schematically illustrating an example of the recording unit. FIG. 3A is a perspective view and FIG. 3B is an exploded perspective view. The recording unit illustrated in each of FIG. 3A and FIG. 3B has an interior (ink storage portion), which is not divided into a plurality of parts and stores single ink. The recording unit includes an ink storage portion 37, which is a casing formed of a thermoplastic resin composition containing a filler material, and the recording head 36. Examples of the thermoplastic resin composition include polyester, polycarbonate, polypropylene, polyethylene, polystyrene, polyphenylene ether and mixtures or modified products thereof. Examples of the filler material may include a flake filler such as mica and a fibrous filler such as a glass fiber. A general glass fiber is a glass fiber (chopped strand) made of a material called E-glass (alkali-free glass) in a form of being cut into a predetermined length. The recording head 36 is preferably attached to the ink storage portion 37 for forming the recording unit without intermediation of any other member. The ink storage portion 37 has a light weight because the portion is a casing formed of a thermoplastic resin composition. The entirety of the recording unit is reduced in size and weight because the recording head 36 is attached to the ink storage portion 37 without intermediation of any other member such as a heat-radiating plate. The use of such recording unit can reduce the size and weight of the entirety of the ink jet recording apparatus. The heat-radiating plate may be, for example, a plate formed of a material such as a metal oxide such as alumina. Further, the ink storage portion 37 formed of the thermoplastic resin composition containing the filler material has a linear expansion coefficient lower than that of a member formed of a thermoplastic resin containing no filler material. Accordingly, the deformation of the casing can be suppressed, and the occurrence of cracking due to an external pressure such as falling can be suppressed.

The direction of the reciprocating movement of the recording head is defined as an X-axis, the direction substantially perpendicular to the direction of the reciprocating movement (sub-scanning direction) is defined as a Y-axis, and the direction of gravity is defined as a Z-axis. In this case, the inner size X of the ink storage portion 37 in the X-axis direction, the inner size Y thereof in the Y-axis direction and the inner size Z thereof in the Z-axis direction correspond to the width, depth and height of the ink storage portion 37, respectively. The inner size X (mm) in the X-axis direction is preferably 10 mm or more to 40 mm or less. The inner size Y (mm) in the Y-axis direction is preferably 30 mm or more to 100 mm or less. The inner size Z (mm) in the Z-axis direction is preferably 20 mm or more to 80 mm or less. Inside the ink storage portion, when a corner portion is formed in a curved shape, a point where straight portions in the respective X-, Y- and Z-axis directions are extended and intersect is defined as a “corner portion,” and an inner size based on the “corner portion” is utilized.

The recording head 36 has arranged therein a plurality of ejection orifices that ejects the ink and an energy-generating element that generates energy for ejecting the ink, such as a thermal energy-generating element or a mechanical energy-generating element. The energy-generating element may be driven by, for example, electric power supplied through an electrical wiring member 32. The thermal energy-generating element is an element that generates thermal energy, and the action of the generated thermal energy can eject the ink from the ejection orifices. The thermal energy-generating element may be, for example, an electrothermal converter. The mechanical energy-generating element may be, for example, a piezoelectric element. Of those, a recording unit including a recording head that ejects the ink by the action of the thermal energy is preferable because the recording head can be designed to be downsized.

The recording head 36 has an ejection orifice surface in which a plurality of ejection orifice arrays each formed of a plurality of ejection orifices is arrayed in the same recording element substrate. When the plurality of ejection orifice arrays is arrayed in the same recording element substrate, a plurality of inks can be ejected by one recording unit, and thus the ink jet recording apparatus can be downsized. The plurality of ejection orifice arrays is preferably arrayed in a direction (sub-scanning direction) substantially perpendicular to the direction of the reciprocating movement (main scanning direction) of the recording unit to which the recording head is attached. In addition, with the ejection orifice array formed of the plurality of ejection orifices, a recordable region at the time of the reciprocating movement of the recording head can be enlarged, and hence fast recording can be performed.

The stagnation portion of the ink in the ink storage portion is liable to occur from each of both the ends of the ejection orifice array in the Y-axis direction of the bottom. Accordingly, as the ratio (L_{N}/Y) of the array length L_{N} (mm) of the ejection orifice array to the inner size Y (mm) of the ink storage portion becomes smaller, the area of the stagnation portion becomes larger, and hence density unevenness tends to occur in an image. When the ratio (L_{N}/Y) of the array length L_{N} (mm) of the ejection orifice array to the inner size Y (mm) of the ink storage portion is 0.80 times or less, the disposability of the ink tends to be liable to reduce. However, according to the ink jet recording method of the present disclosure, even when the value of the ratio L_{N}/Y is 0.80 times or less, the occurrence of the density unevenness of an image can be effectively suppressed. The value of the ratio L_{N}/Y is preferably 0.10 times or more. The array length L_{N} (mm) of the ejection orifice array is preferably 10 mm or more to 60 mm or less, more preferably 15 mm or more to 30 mm or less.

When the center position of the ejection orifice array of the recording head in the Y-axis direction and the center position of the ink storage portion in the Y-axis direction match each other, the areas of the stagnation portions generated from both the ends of the ejection orifice array in the Y-axis direction of the bottom of the ink storage portion are substantially equal to each other. Meanwhile, when the center position of the ejection orifice array of the recording head in the Y-axis direction and the center position of the ink storage portion in the Y-axis direction are shifted from each other (do not match each other), unlike the case where both the positions match each other, the area of one stagnation portion becomes larger, and hence the density unevenness of the image tends to be liable to occur. However, according to the ink jet recording method of the present disclosure, even when the center position of the ejection orifice array of the recording head in the Y-axis direction and the center position of the ink storage portion in the Y-axis direction are shifted from each other, the occurrence of the density unevenness of the image can be effectively suppressed. This is probably because the water-soluble organic solvent having a high average relative dielectric constant suppresses the aggregation of the pigment in the ink of the stagnation portion.

The ink can be directly stored in the ink storage portion. In addition, as illustrated in FIG. 3B, it is preferable that the ink storage portion 37 internally include an ink absorbent 34 that generates a negative pressure for absorbing the ink to hold the ink. A fiber compressed body obtained by laminating and compressing fibers formed of a resin material, such as polyolefin like polypropylene or urethane, is preferably used as the ink absorbent. The bulk density ρ_{b} of the ink absorbent is preferably 0.05 g/cm³ or more to 0.12 g/cm³ or less. When the bulk density ρ_{b} of the ink absorbent is less than 0.05 g/cm³, a suppressing effect on the sedimentation of the pigment may reduce slightly. Meanwhile, when the bulk density ρ_{b} of the ink absorbent is more than 0.12 g/cm³, the negative pressure of the ink absorbent may increase excessively. Thus, quick discharge of the ink in the stagnation portion is liable to be inhibited, and hence a suppressing effect on the occurrence of the density unevenness of the image reduces in some cases. The bulk density may be calculated as a value obtained by dividing the mass (g) of the ink absorbent by the volume (cm³) thereof. When the bulk density of the ink absorbent is determined from the recording unit storing the ink, for example, the determination may be performed as described below. The volume of the ink absorbent is calculated by calculating the sizes thereof as a form stored in the ink storage portion. In addition, the mass of the ink absorbent is measured after the ink absorbent has been sufficiently washed. The bulk density may be calculated from the mass and the volume thus determined.

The bulk density of the ink absorbent is defined as “ρ_{b} (g/cm³),” and the viscosity of the evaporated ink, which is obtained by evaporating 40% by mass of the ink, is defined as “η₄₀ (mPa·s).” As a result of an investigation, the inventors have found that two parameters “ρ_{b}×η₄₀” and “ρ_{b}×γ” are useful as parameters indicating a relationship between the fluidity of the ink and the negative pressure of the ink absorbent. Ink having a large viscosity η₄₀ when evaporated is liable to thicken when a pigment in the ink sediments at the bottom of the ink absorbent. The parameter represented by “ρ_{b}×η₄₀” is a parameter that takes into account a reduction in fluidity of the ink due to the negative pressure generated by the ink absorbent and a reduction in fluidity of the ink at the bottom of the ink storage portion due to the sedimentation of the pigment. Accordingly, as the value of the parameter “ρ_{b}×η₄₀” becomes larger, the fluidity of the ink in the ink absorbent is more liable to reduce.

The bulk density ρ_{b} (g/cm³) of the ink absorbent and the viscosity η₄₀ (mPa·s) of the evaporated ink, which is obtained by evaporating 40% by mass of the ink, preferably satisfy the relationship of the following formula (4), and more preferably satisfy the relationship of the following formula (5). When the value of the parameter “ρ_{b}×η₄₀” is 3.4 or less, even in the case where the concentration of the pigment in the ink at the bottom of the ink storage portion increases owing to the sedimentation of the pigment, a reduction in fluidity of the ink is mitigated. Thus, the occurrence of the density unevenness can be more effectively suppressed. Meanwhile, when the value of the parameter “ρ_{b}×η₄₀” is more than 3.4, an increase in negative pressure of the ink absorbent and the thickening of the ink with an increased pigment concentration act synergistically. Thus, the fluidity of the ink in the ink absorbent may be liable to reduce, and hence a suppressing effect on the occurrence of the density unevenness may reduce. The value of the parameter “ρ_{b}×η₄₀” is preferably 0.1 or more, more preferably 0.2 or more.

$${ρ}_{b} \times {η}_{40} \leq 3.4 \qquad ( 4 )$$

$${ρ}_{b} \times {η}_{40} \leq 2.0 \qquad ( 5 )$$

The surface tension γ (mN/m) of the ink is a physical property value serving as an index of the wettability of the ink with respect to each of the inner wall of the ink storage portion and the ink absorbent. When the ink sedimented at the bottom of the ink storage portion flows toward an ejection orifice, as the value of the surface tension becomes larger, the wettability becomes lower, and hence the ink hardly flows. As the value of the surface tension becomes smaller, the wettability becomes higher, and hence the ink easily flows. Accordingly, it can be said that the parameter defined by “ρ_{b}×γ” is a parameter that takes into account a reduction in fluidity of the ink due to the negative pressure generated by the ink absorbent and the ease of flow of the ink based on the wettability of the ink. As the value of the parameter “ρ_{b}×γ” becomes larger, the fluidity of the ink in the ink absorbent becomes lower, and as the value of the parameter “ρ_{b}×γ” becomes smaller, the fluidity of the ink in the ink absorbent becomes higher.

The bulk density ρ_{b} (g/cm³) of the ink absorbent and the surface tension Y (mN/m) of the ink preferably satisfy the relationship of the following formula (6), and more preferably satisfy the relationship of the following formula (7). When the value of the parameter “ρ_{b}×γ” is set to 1.3 or more to 5.4 or less, even in the case where the pigment concentration of the ink at the bottom of the ink storage portion increases owing to the sedimentation of the pigment, a reduction in fluidity of the ink can be effectively mitigated. Thus, the ink at the bottom can be flowed to the ejection orifice and discharged more quickly, and hence the occurrence of the density unevenness can be more effectively suppressed.

$$1.3 \leq {ρ}_{b} \times γ \leq 5.4 \qquad ( 6 )$$

$$1.5 \leq {ρ}_{b} \times γ \leq 4.4 \qquad ( 7 )$$

When the value of the parameter “ρ_{b}×γ” is less than 1.3, the fluidity of the ink in the ink absorbent may increase excessively. As a result, a difference between the supply speed of the ink having an increased pigment concentration and the supply speed of normal ink becomes larger to facilitate the suppression of the ejection of the ink having an increased pigment concentration, and hence a suppressing effect on the occurrence of the density unevenness reduces in some cases. Meanwhile, when the value of the parameter “ρ_{b}×γ” is more than 5.4, the fluidity of the ink at the bottom of the ink storage portion is liable to reduce, and hence the suppressing effect on the occurrence of the density unevenness reduces in some cases.

As illustrated in FIG. 3B, a filter 35 is arranged below the ink storage portion 37 in the direction of gravity. The arrangement of the filter 35 enables the suppression of the intrusion of fine foreign matter such as dust into the ejection orifice. Further, the arrangement of a lid 33 by thermal compression bonding above the ink storage portion 37 in the direction of gravity can suppress the leakage of the ink from the ink storage portion 37.

The recording head preferably includes a warming unit that warms the ink in the recording head. The warming unit only needs to be a unit that can warm the ink in the recording head to a temperature higher than a recording environment temperature such as a room temperature (25° C.). Examples of such warming unit may include: a heater for ink temperature control arranged so as to be brought into contact with the recording head; and a heater for ink ejection. To warm the ink with the heater for ink ejection, for example, such a current that the ink is not ejected only needs to be repeatedly passed through the heater.

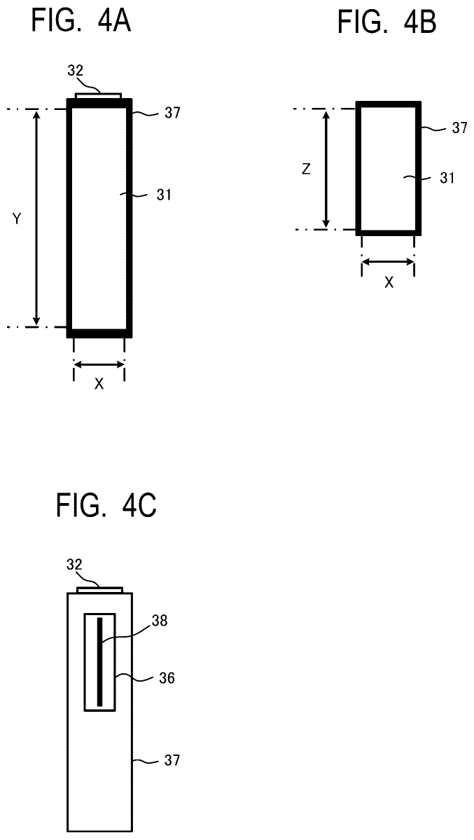

FIG. 4A, FIG. 4B and FIG. 4C are each a view for schematically illustrating an example of the recording unit. FIG. 4A is a top view with the lid removed, FIG. 4B is a front view, and FIG. 4C is a bottom view. As illustrated in each of FIG. 4A and FIG. 4B, the ink storage portion 37 has a storage portion 31 that stores the ink. In addition, the recording head 36 has an ejection orifice surface in which an ejection orifice array 38 is arranged on the same recording element substrate. The ejection orifice array 38 corresponds to the ink stored in the storage portion 31.

The inner size X (mm) of the ink storage portion 37 in the X-axis direction, the inner size Y (mm) thereof in the Y-axis direction and the inner size Z (mm) thereof in the Z-axis direction satisfy the relationships of the following formulae (1) and (2) (FIG. 4A and FIG. 4B). When the inner size Y is set to be 2.4 times or more as large as the inner size X, the width of the ink jet recording apparatus can be reduced. In order to record an image on the entire surface of a recording medium with a so-called serial type ink jet recording apparatus that records an image while reciprocating its recording head in a main scanning direction substantially perpendicular to the conveying direction of the recording medium, its ejection orifice array needs to be moved from one end of the recording medium to the other end thereof. When the inner size X corresponding to the width of the ink storage portion is too large, the width of the ink jet recording apparatus inevitably increases. In addition, when the inner size Y corresponding to the depth of the ink storage portion is too large, a suppressing effect on the density unevenness of the image occurring in the direction of the ejection orifice array reduces. Accordingly, from the viewpoints of downsizing the ink jet recording apparatus and suppressing the occurrence of the density unevenness of the image, the inner size Y of the ink storage portion needs to be 4.0 times or less as large as the inner size X.

$$2.4 X \leq Y \leq 4. X \qquad ( 1 )$$

$$1. X < Z \leq 30 X \qquad ( 2 )$$

In addition, when the inner size Z of the ink storage portion is set to be more than 1.0 times as large as the inner size X, the width of the ink jet recording apparatus can be reduced while the volume of the ink storage portion is secured. Accordingly, the inner size X and the inner size Z more preferably satisfy the relationship of the following formula (8). Meanwhile, when the inner size Z corresponding to the height of the ink storage portion is too large, the sedimentation of the pigment becomes remarkable to make it become difficult to suppress the occurrence of the density unevenness of an image. Accordingly, the inner size Z of the ink storage portion needs to be 3.0 times or less as large as the inner size X.

$$1. 1 X \leq Z \leq 3 \text{.0} X \qquad ( 8 )$$

FIG. 2 is a perspective view for schematically illustrating an example of the recording unit. As illustrated in each of FIG. 1 and FIG. 2, to suppress, for example, the clogging of the ejection orifice array 38 arranged in a row on the recording head 36, a protection unit 82 covers the surface of the recording head having arranged thereon the ejection orifice (ejection orifice surface 39) when no recording is performed. The protection unit 82 includes a cap 41 so as to correspond to the recording head 36. In addition, when no recording is performed, the recording unit is moved to a position corresponding to the cap 41 by the carriage, and the cap 41 is brought into abutment with the ejection orifice surface 39 to form a sealed space (capping).

When the recording apparatus is left over a long time period during distribution or after the recording unit has been mounted on a recording apparatus main body, the ink existing at the bottom of the ink storage portion thickens owing to the sedimentation of the pigment, and hence its fluidity reduces. In such case, the ink stagnates at a position away from an ejection orifice and continues to be supplied slowly to the ejection orifice without mixing with non-concentrated ink. Accordingly, a pigment concentration gradient occurs in the array direction of the ejection orifice array, and hence the density unevenness of an image is liable to occur. In each of many related-art ink jet recording apparatus, the following suction operation has been performed: a cap is brought into abutment with an ejection orifice surface; and a suction pump connected to the cap is operated to forcibly discharge ink through an ejection orifice. When such suction operation is performed, the ink stagnant at the bottom of an ink storage portion is easily discharged, and hence the occurrence of the density unevenness of an image can be suppressed. However, the arrangement of a suction mechanism including suction members, such as a suction cap and a suction pump, increases the mass of the recording apparatus and leads to an increase in size thereof. In contrast, for weight reduction and downsizing, the ink jet recording apparatus of the present disclosure is free of a suction mechanism, which includes suction members, such as a suction cap and a suction pump, and sucks the ink in the recording head through the ejection orifice. Accordingly, the density unevenness of an image caused by ink stagnation can be suppressed only by so-called preliminary ejection of discharging the ink from the ejection orifice of the recording head and ejection during recording.

### EXAMPLES

The present disclosure is described in more detail below by way of Examples and Comparative Examples. However, the present disclosure is by no means limited to Examples below, and various modifications are possible without departing from the gist of the present disclosure. In the description of the amounts of components, “part(s)” and “%” are by mass unless otherwise specified.

### <Preparation of Pigment Dispersion Liquid>

### (Method of Measuring Anionic Group Amount of Self-Dispersible Pigment)

A pigment dispersion liquid was diluted with pure water so that the content of its pigment became 5.0%. After that, centrifugal separation treatment was performed with an ultracentrifuge (product name: “Optima MAX-XP”, manufactured by Beckman Coulter, Inc.) under the conditions of 80,000 rpm and 2 hours to sediment the pigment. The sedimented pigment was redispersed in pure water whose mass was 30 times as large as that of the pigment to prepare a measurement liquid. The anionic group amount of the self-dispersible pigment in the measurement liquid was measured with an automatic potentiometric titrator (product name: “AT-510”, manufactured by Kyoto Electronics Manufacturing Co., Ltd.) mounted with a streaming potential titration unit (PCD-500) by colloidal titration using a potential difference. Methyl glycol chitosan was used as a titration reagent.

### (Method of Measuring Average Particle Diameter of Pigment)

The average particle diameter (cumulative 50% particle diameter in a volume-based particle size distribution (D50 (nm)) of the pigment in a sample obtained by diluting the pigment dispersion liquid 1,000 times (based on mass) with pure water was measured with a particle size analyzer by a dynamic light scattering method. A product available under the product name “Nanotrac UPA-EX150” (manufactured by MicrotracBEL Corp.) was used as the particle size distribution meter. The measurement was performed under the following conditions: Set Zero: 30 seconds, number of times of measurement: 3 times, measurement time: 120 seconds, shape: non-spherical, and refractive index: 1.80. The D50 measured for the pigment in the pigment dispersion liquid was equivalent to a D50 measured for a pigment in prepared ink.

### (Pigment Dispersion Liquids 1, 3 to 7 and 12 to 15)

250.0 Grams of pure water, 30.0 g of a pigment whose kind was shown in Table 1 and a treatment agent whose kind and addition amount were shown in Table 1 were mixed to provide a mixed liquid. While the resultant mixed liquid was cooled to 10° C. and stirred, a 10% aqueous solution of potassium nitrite whose addition amount was shown in Table 1 was slowly added thereto, followed by stirring for 15 minutes. The mixture was stirred with a precision emulsification disperser (product name: “CLEARMIX CLM-0.8S”, manufactured by M Technique Co., Ltd.) at a number of revolutions of 10,000 rpm for 4 hours, and then an 8 mol/L aqueous solution of potassium hydroxide was added to adjust its pH to 10. The mixture was purified by ultrafiltration until the electrical conductivity of a filtrate became 50 μS/cm or less. After that, coarse particles were removed from the filtrate by centrifugation at a number of revolutions of 10,000 rpm for 30 minutes. An appropriate amount of ion-exchange water was added to the residue to adjust the content of the pigment. Thus, pigment dispersion liquids 1, 3 to 7 and 12 to 15 in each of which the content of the pigment was 10.0% and an anionic group amount was shown in Table 1 were obtained.

### (Pigment Dispersion Liquid 2)

300.0 Grams of the same carbon black as the carbon black used at the time of the preparation of the pigment dispersion liquid 1 and 2,000.0 g of pure water were loaded into a simplified glass autoclave (product name: “TEM-U1000N”, manufactured by Taiatsu Techno Corp.) and stirred. The flow rate of an ozone gas generated by using an ozone generator (product name: “KQS-120”, manufactured by Kotohira Kogyo Co., Ltd.) was adjusted to 13.2 (g/h), and the gas was introduced into the autoclave, followed by ozone oxidation treatment for 10 hours under stirring. Thus, a dispersion liquid was obtained. The pH of the resultant dispersion liquid was adjusted to from 8 to 9 by adding an 8 mol/L aqueous solution of potassium hydroxide, and then the dispersion liquid was purified by ultrafiltration until the electrical conductivity of a filtrate became 50 μS/cm or less. Coarse particles were removed from the filtrate by centrifugation at a number of revolutions of 10,000 rpm for 30 minutes. An appropriate amount of ion-exchange water was added to the residue to adjust the content of the pigment. Thus, a pigment dispersion liquid 2 in which the content of the self-dispersible pigment was 10.0% was prepared.

### (Pigment Dispersion Liquid 8)

A water-soluble resin was neutralized with potassium hydroxide in an equimolar amount to its acid value, and was dissolved in ion-exchange water to prepare an aqueous solution of a resin dispersant having a resin content (solid content) of 20.0%. A styrene-acrylic acid copolymer (composition (molar) ratio=33:67, weight-average molecular weight: 10,000, acid value: 200 mgKOH/g) was used as the water-soluble resin. A mixture of 15.0 parts of carbon black, 22.5 parts of the aqueous solution of the resin dispersant and 62.5 parts of water was loaded into a sand grinder and subjected to dispersion treatment for 1 hour. After that, coarse particles were removed by centrifugation treatment. The resultant was pressure-filtered through a microfilter having a pore size of 3.0 μm (manufactured by FUJIFILM Corporation). After that, an appropriate amount of ion-exchange water was added to the filtrate to provide a pigment dispersion liquid 8. The content of the pigment in the pigment dispersion liquid 8 was 10.0%, and the content of the resin dispersant therein was 3.0%.

### (Pigment Dispersion Liquid 9)

A pigment dispersion liquid 9 was obtained in the same manner as in the pigment dispersion liquid 7 described above except that C.I. Pigment Blue 15:3 was used instead of the carbon black. The content of the pigment in the pigment dispersion liquid 9 was 10.0%, and the content of the resin dispersant therein was 3.0%.

### (Pigment Dispersion Liquid 10)

A pigment dispersion liquid 10 was obtained in the same manner as in the pigment dispersion liquid 7 described above except that C.I. Pigment Red 122 was used instead of the carbon black. The content of the pigment in the pigment dispersion liquid 10 was 10.0%, and the content of the resin dispersant therein was 3.0%.

### (Pigment Dispersion Liquid 11)

A pigment dispersion liquid 11 was obtained in the same manner as in the pigment dispersion liquid 7 described above except that C.I. Pigment Yellow 74 was used instead of the carbon black. The content of the pigment in the pigment dispersion liquid 11 was 10.0%, and the content of the resin dispersant therein was 3.0%.

TABLE 1
Preparation conditions and characteristics of pigment dispersion liquid

| | | | | | Addition | | |
|---|---|---|---|---|---|---|---|
| | | Specific | Treatment agent | | amount of | Anionic | Average |
| Pigment | | surface | | Addition | 10% KNO₂ | group | particle |
| dispersion | Kind of | area | | amount | aqueous | amount | diameter |
| liquid | pigment | (m²/g) | Kind | (g) | solution (g) | (mmol/g) | D50 (nm) |
| 1 | Carbon | 260 | 4-Aminophthalic | 5.5 | 43.4 | 0.20 | 120 |
| | black | | acid | | | | |
| 2 | Carbon | 260 | — | — | — | 0.17 | 120 |
| | black | | | | | | |
| 3 | Carbon | 260 | 2-Aminoterephthalic | 4.8 | 37.6 | 0.16 | 120 |
| | black | | acid | | | | |
| 4 | Carbon | 500 | 4-Aminophthalic | 19.3 | 152.3 | 0.29 | 35 |
| | black | | acid | | | | |
| 5 | Carbon | 500 | 4-Aminophthalic | 13.8 | 108.9 | 0.25 | 40 |
| | black | | acid | | | | |
| 6 | Carbon | 110 | 4-Aminophthalic | 4.4 | 34.7 | 0.16 | 220 |
| | black | | acid | | | | |
| 7 | Carbon | 110 | 4-Aminophthalic | 3.9 | 30.8 | 0.15 | 230 |
| | black | | acid | | | | |
| 8 | Carbon | 260 | — | — | — | — | 120 |
| | black | | | | | | |
| 9 | C.I. | 90 | — | — | — | — | 120 |
| | Pigment | | | | | | |
| | Blue 15:3 | | | | | | |
| 10 | C.I. | 122 | — | — | — | — | 120 |
| | Pigment | | | | | | |
| | Red 122 | | | | | | |
| 11 | C.I. | 60 | — | — | — | — | 150 |
| | Pigment | | | | | | |
| | Yellow 74 | | | | | | |
| 12 | Carbon | 260 | 4-Aminophthalic | 1.7 | 13.4 | 0.06 | 135 |
| | black | | acid | | | | |
| 13 | Carbon | 260 | 4-Aminophthalic | 2.2 | 17.4 | 0.08 | 125 |
| | black | | acid | | | | |
| 14 | Carbon | 370 | 4-Aminophthalic | 22.0 | 173.6 | 0.30 | 110 |
| | black | | acid | | | | |
| 15 | Carbon | 370 | 4-Aminophthalic | 24.8 | 195.6 | 0.32 | 110 |
| | black | | acid | | | | |
| 16 | Carbon | 110 | 4-Aminophthalic | 1.5 | 11.8 | 0.06 | 230 |
| | black | | acid | | | | |

### <Production of Resin>

### (Aqueous Solution of Urethane Resin)

39.3 Grams of polytetramethylene glycol having a number-average molecular weight of 2,000, 44.5 g of isophorone diisocyanate and 0.007 g of dibutyltin dilaurate were loaded into a four-necked flask including a temperature gauge, a stirring machine, a nitrogen-introducing tube and a cooling tube. The materials were caused to react with each other under a nitrogen gas atmosphere at a temperature of 100° C. for 5 hours, and then the resultant was cooled to a temperature of 65° C. or less. 13.2 Grams of dimethylolpropionic acid, 3.0 g of neopentyl glycol and 150.0 g of methyl ethyl ketone were added to the cooled product, and the mixture was subjected to a reaction at a temperature of 80° C. After that, the resultant was cooled to a temperature of 40° C., and 20.0 g of methanol was added thereto to stop the reaction. Next, an appropriate amount of ion-exchange water was added to the mixture, and while the whole was stirred with a homomixer, an aqueous solution of potassium hydroxide required for the neutralization of a resin was added thereto. After that, methyl ethyl ketone and unreacted methanol were evaporated under heating and reduced pressure. Thus, an aqueous solution of a urethane resin, which contained the urethane resin having an acid value of 55 mgKOH/g and a weight-average molecular weight of 15,000, and in which the content of the resin (solid content) was 20.0%, was prepared.

### <Preparation of Ink>

Respective components (unit: %) shown in the middle part of Table 2 (Table 2-1 to Table 2-9) were mixed and sufficiently stirred, and then the mixture was pressure-filtered through a membrane filter having a pore size of 2.5 μm (product name: “HDCII Filter”, manufactured by Pall Corporation) to prepare each ink. In Table 2, the terms “Acetylenol E00”, “Acetylenol E200”, “Acetylenol E100” and “Acetylenol E60” each refer to the product name of a nonionic surfactant manufactured by Kawaken Fine Chemicals Co., Ltd. All of those nonionic surfactants are ethylene oxide adducts of acetylene glycol (compounds each represented by the general formula (A)). In addition, the term “NIKKOL BL-9EX” refers to the product name of a nonionic surfactant (polyoxyethylene alkyl ether) manufactured by Nikko Chemicals Co., Ltd. The term “Uniox G-1200” refers to the product name of a nonionic surfactant (ethylene oxide adduct of glycerin, compound represented by the general formula (B)) manufactured by NOF Corporation. The term “KF-6012” refers to the product name of a silicone-based nonionic surfactant manufactured by Shin-Etsu Silicone.

TABLE 2-1
Composition and characteristics of ink

| | Ink | | | | |
|---|---|---|---|---|---|
| | 1 | 2 | 3 | 4 | 5 |
| Kind of pigment dispersion liquid | 1 | 2 | 3 | 1 | 1 |
| Pigment dispersion liquid | 30.00 | 30.00 | 30.00 | 30.00 | 30.00 |
| C.I. Direct Black 195 | | | | | |
| Glycerin (42.7) | 10.00 | 10.00 | 10.00 | 7.10 | 17.40 |
| 1,5-Pentanediol (27.0) | | | | | |
| Triethylene glycol (22.3) | 10.00 | 10.00 | 10.00 | 6.90 | 2.60 |
| 1,6-Hexanediol (7.1) | | | | 6.00 | |
| Aqueous solution of urethane resin | | | | | |
| Acetylenol E00 | 0.10 | 0.10 | 0.10 | 0.10 | 0.10 |
| NIKKOL BL-9EX | | | | | |
| Acetylenol E200 | | | | | |
| Acetylenol E100 | | | | | |
| Acetylenol E60 | | | | | |
| Uniox G-1200 | | | | | |
| KF-6012 | | | | | |
| Ion-exchange water | 49.90 | 49.90 | 49.90 | 49.90 | 49.90 |
| Pigment content P (%) | 3.00 | 3.00 | 3.00 | 3.00 | 3.00 |
| Content S of water-soluble organic | 20.00 | 20.00 | 20.00 | 20.00 | 20.00 |
| solvent (%) | | | | | |
| Content S₁ of first water-soluble | 10.00 | 10.00 | 10.00 | 7.10 | 17.40 |
| organic solvent (%) | | | | | |
| Content S₂ of second water-soluble | 10.00 | 10.00 | 10.00 | 7.10 | 17.40 |
| organic solvent (%) | | | | | |
| Value of S/P (times) | 3.3 | 3.3 | 3.3 | 2.4 | 5.8 |
| Average relative dielectric constant of | 32.5 | 32.5 | 32.5 | 25.0 | 40.0 |
| water-soluble organic solvent | | | | | |
| (S₁/S) · 100 (%) | 50.0 | 50.0 | 50.0 | 35.5 | 87.0 |
| (S₂/S) · 100 (%) | 50.0 | 50.0 | 50.0 | 35.5 | 87.0 |
| Viscosity η₀ of ink (mN/m) | 2.2 | 2.2 | 2.2 | 2.2 | 2.2 |
| Viscosity η₄₀ of evaporated ink | 4.0 | 3.5 | 4.2 | 4.2 | 3.8 |
| (mN/m) | | | | | |
| Value of η₄₀/η₀ (times) | 1.8 | 1.6 | 1.9 | 1.9 | 1.7 |
| Surface tension γ of ink (mN/m) | 37 | 37 | 37 | 37 | 37 |

TABLE 2-2
Composition and characteristics of ink

| | Ink | | | | |
|---|---|---|---|---|---|
| | 6 | 7 | 8 | 9 | 10 |
| Kind of pigment dispersion liquid | 1 | 1 | 1 | 1 | 1 |
| Pigment dispersion liquid | 30.00 | 30.00 | 30.00 | 30.00 | 30.00 |
| C.I. Direct Black 195 | | | | | |
| Glycerin (42.7) | 6.50 | 6.00 | 7.00 | 16.00 | 18.00 |
| 1,5-Pentanediol (27.0) | | 1.00 | | 2.00 | |
| Triethylene glycol (22.3) | 13.50 | 13.00 | 13.00 | 2.00 | 2.00 |
| 1,6-Hexanediol (7.1) | | | | | |
| Aqueous solution of urethane resin | | | | | |
| Acetylenol E00 | 0.10 | 0.10 | 0.10 | 0.10 | 0.10 |
| NIKKOL BL-9EX | | | | | |
| Acetylenol E200 | | | | | |
| Acetylenol E100 | | | | | |
| Acetylenol E60 | | | | | |
| Uniox G-1200 | | | | | |
| KF-6012 | | | | | |
| Ion-exchange water | 49.90 | 49.90 | 49.90 | 49.90 | 49.90 |
| Pigment content P (%) | 3.00 | 3.00 | 3.00 | 3.00 | 3.00 |
| Content S of water-soluble organic | 20.00 | 20.00 | 20.00 | 20.00 | 20.00 |
| solvent (%) | | | | | |
| Content S₁ of first water-soluble | 6.50 | 7.00 | 7.00 | 18.00 | 18.00 |
| organic solvent (%) | | | | | |
| Content S₂ of second water-soluble | 6.50 | 6.00 | 7.00 | 16.00 | 18.00 |
| organic solvent (%) | | | | | |
| Value of S/P (times) | 2.2 | 2.3 | 2.3 | 6.0 | 6.0 |
| Average relative dielectric constant of | 28.9 | 28.7 | 29.4 | 39.1 | 40.7 |
| water-soluble organic solvent | | | | | |
| (S₁/S) · 100 (%) | 32.5 | 35.0 | 35.0 | 90.0 | 90.0 |
| (S₂/S) · 100 (%) | 32.5 | 30.0 | 35.0 | 80.0 | 90.0 |
| Viscosity η₀ of Ink (mN/m) | 2.2 | 2.2 | 2.2 | 2.2 | 2.2 |
| Viscosity η₄₀ of evaporated ink | 4.0 | 4.0 | 4.0 | 4.2 | 3.8 |
| (mN/m) | | | | | |
| Value of η₄₀/η₀ (times) | 1.8 | 1.8 | 1.8 | 1.9 | 1.7 |
| Surface tension γ of ink (mN/m) | 38 | 38 | 38 | 37 | 37 |

TABLE 2-3
Composition and characteristics of ink

| | Ink | | | | |
|---|---|---|---|---|---|
| | 11 | 12 | 13 | 14 | 15 |
| Kind of pigment dispersion liquid | 1 | 1 | 1 | 1 | 1 |
| Pigment dispersion liquid | 30.00 | 30.00 | 30.00 | 30.00 | 30.00 |
| C.I. Direct Black 195 | | | | | |
| Glycerin (42.7) | 10.00 | 10.00 | 10.00 | 10.00 | 10.00 |
| 1,5-Pentanediol (27.0) | | | | | |
| Triethylene glycol (22.3) | 10.00 | 10.00 | 10.00 | 10.00 | 10.00 |
| 1,6-Hexanediol (7.1) | | | | | |
| Aqueous solution of urethane resin | | | | | |
| Acetylenol E00 | | | | | |
| NIKKOL BL-9EX | 0.10 | | | | |
| Acetylenol E200 | | 0.40 | | | |
| Acetylenol E100 | | | 0.20 | | |
| Acetylenol E60 | | | | 0.10 | |
| Uniox G-1200 | | | | | 0.50 |
| KF-6012 | | | | | |
| Ion-exchange water | 49.90 | 49.60 | 49.80 | 49.90 | 49.50 |
| Pigment content P (%) | 3.00 | 3.00 | 3.00 | 3.00 | 3.00 |
| Content S of water-soluble organic | 20.00 | 20.00 | 20.00 | 20.00 | 20.00 |
| solvent (%) | | | | | |
| Content S₁ of first water-soluble | 10.00 | 10.00 | 10.00 | 10.00 | 10.00 |
| organic solvent (%) | | | | | |
| Content S₂ of second water-soluble | 10.00 | 10.00 | 10.00 | 10.00 | 10.00 |
| organic solvent (%) | | | | | |
| Value of S/P (times) | 3.3 | 3.3 | 3.3 | 3.3 | 3.3 |
| Average relative dielectric constant of | 32.5 | 32.5 | 32.5 | 32.5 | 32.5 |
| water-soluble organic solvent | | | | | |
| (S₁/S) · 100 (%) | 50.0 | 50.0 | 50.0 | 50.0 | 50.0 |
| (S₂/S) · 100 (%) | 50.0 | 50.0 | 50.0 | 50.0 | 50.0 |
| Viscosity η₀ of Ink (mN/m) | 2.2 | 2.2 | 2.2 | 2.2 | 2.2 |
| Viscosity η₄₀ of evaporated ink | 4.0 | 4.0 | 4.0 | 4.0 | 4.0 |
| (mN/m) | | | | | |
| Value of η₄₀/η₀ (times) | 1.8 | 1.8 | 1.8 | 1.8 | 1.8 |
| Surface tension γ of ink (mN/m) | 31 | 51 | 37 | 34 | 52 |

TABLE 2-4
Composition and characteristics of ink

| | Ink | | | | |
|---|---|---|---|---|---|
| | 16 | 17 | 18 | 19 | 20 |
| Kind of pigment dispersion liquid | 1 | 1 | 1 | 1 | 1 |
| Pigment dispersion liquid | 30.00 | 30.00 | 30.00 | 40.00 | 43.00 |
| C.I. Direct Black 195 | | | | | |
| Glycerin (42.7) | 10.00 | 4.00 | 7.00 | 10.00 | 10.00 |
| 1,5-Pentanediol (27.0) | | | | | |
| Triethylene glycol (22.3) | 10.00 | 7.00 | 7.00 | 10.00 | 10.00 |
| 1,6-Hexanediol (7.1) | | | | | |
| Aqueous solution of urethane resin | | | | 4.00 | 4.00 |
| Acetylenol E00 | 0.10 | 0.10 | 0.10 | 0.10 | 0.12 |
| NIKKOL BL-9EX | | | | | |
| Acetylenol E200 | | | | | |
| Acetylenol E100 | | | | | |
| Acetylenol E60 | | | | | |
| Uniox G-1200 | 0.30 | | | | |
| KF-6012 | | | | | |
| Ion-exchange water | 49.60 | 58.90 | 55.90 | 35.90 | 32.88 |
| Pigment content P (%) | 3.00 | 3.00 | 3.00 | 4.00 | 4.30 |
| Content S of water-soluble organic | 20.00 | 11.00 | 14.00 | 20.00 | 20.00 |
| solvent (%) | | | | | |
| Content S₁ of first water-soluble | 10.00 | 4.00 | 7.00 | 10.00 | 10.00 |
| organic solvent (%) | | | | | |
| Content S₂ of second water-soluble | 10.00 | 4.00 | 7.00 | 10.00 | 10.00 |
| organic solvent (%) | | | | | |
| Value of S/P (times) | 3.3 | 1.3 | 2.3 | 2.5 | 2.3 |
| Average relative dielectric constant of | 32.5 | 29.7 | 32.5 | 32.5 | 32.5 |
| water-soluble organic solvent | | | | | |
| (S₁/S) · 100 (%) | 50.0 | 36.4 | 50.0 | 50.0 | 50.0 |
| (S₂/S) · 100 (%) | 50.0 | 36.4 | 50.0 | 50.0 | 50.0 |
| Viscosity η₀ of Ink (mN/m) | 2.2 | 1.5 | 1.7 | 3.9 | 4.0 |
| Viscosity η₄₀ of evaporated ink | 4.0 | 3.0 | 3.2 | 28.5 | 30.0 |
| (mN/m) | | | | | |
| Value of η₄₀/η₀ (times) | 1.8 | 2.0 | 1.9 | 7.3 | 7.5 |
| Surface tension γ of ink (mN/m) | 36 | 38 | 38 | 37 | 37 |

TABLE 2-5
Composition and characteristics of ink

| | Ink | | | | |
|---|---|---|---|---|---|
| | 21 | 22 | 23 | 24 | 25 |
| Kind of pigment dispersion liquid | 1 | 4 | 5 | 6 | 7 |
| Pigment dispersion liquid | 50.00 | 30.00 | 30.00 | 30.00 | 30.00 |
| C.I. Direct Black 195 | | | | | |
| Glycerin (42.7) | 10.00 | 10.00 | 10.00 | 10.00 | 10.00 |
| 1,5-Pentanediol (27.0) | | | | | |
| Triethylene glycol (22.3) | 10.00 | 10.00 | 10.00 | 10.00 | 10.00 |
| 1,6-Hexanediol (7.1) | | | | | |
| Aqueous solution of urethane resin | 4.00 | | | | |
| Acetylenol E00 | 0.10 | 0.10 | 0.10 | 0.10 | 0.10 |
| NIKKOL BL-9EX | | | | | |
| Acetylenol E200 | | | | | |
| Acetylenol E100 | | | | | |
| Acetylenol E60 | | | | | |
| Uniox G-1200 | | | | | |
| KF-6012 | | | | | |
| Ion-exchange water | 25.90 | 49.90 | 49.90 | 49.90 | 49.90 |
| Pigment content P (%) | 5.00 | 3.00 | 3.00 | 3.00 | 3.00 |
| Content S of water-soluble organic | 20.00 | 20.00 | 20.00 | 20.00 | 20.00 |
| solvent (%) | | | | | |
| Content S₁ of first water-soluble | 10.00 | 10.00 | 10.00 | 10.00 | 10.00 |
| organic solvent (%) | | | | | |
| Content S₂ of second water-soluble | 10.00 | 10.00 | 10.00 | 10.00 | 10.00 |
| organic solvent (%) | | | | | |
| Value of S/P (times) | 2.0 | 3.3 | 3.3 | 3.3 | 3.3 |
| Average relative dielectric constant of | 32.5 | 32.5 | 32.5 | 32.5 | 32.5 |
| water-soluble organic solvent | | | | | |
| (S₁/S) · 100 (%) | 50.0 | 50.0 | 50.0 | 50.0 | 50.0 |
| (S₂/S) · 100 (%) | 50.0 | 50.0 | 50.0 | 50.0 | 50.0 |
| Viscosity η₀ of Ink (mN/m) | 4.4 | 2.9 | 2.5 | 2.2 | 2.2 |
| Viscosity η₄₀ of evaporated ink | 35.0 | 18.9 | 16.1 | 4.0 | 3.8 |
| (mN/m) | | | | | |
| Value of η₄₀/η₀ (times) | 8.0 | 6.5 | 6.4 | 1.8 | 1.7 |
| Surface tension γ of ink (mN/m) | 37 | 37 | 37 | 37 | 37 |

TABLE 2-6
Composition and characteristics of ink

| | Ink | | | | |
|---|---|---|---|---|---|
| | 26 | 27 | 28 | 29 | 30 |
| Kind of pigment dispersion liquid | 8 | 9 | 10 | 11 | 12 |
| Pigment dispersion liquid | 30.00 | 30.00 | 30.00 | 30.00 | 30.00 |
| C.I. Direct Black 195 | | | | | |
| Glycerin (42.7) | 10.00 | 10.00 | 10.00 | 10.00 | 10.00 |
| 1,5-Pentanediol (27.0) | | | | | |
| Triethylene glycol (22.3) | 10.00 | 10.00 | 10.00 | 10.00 | 10.00 |
| 1,6-Hexanediol (7.1) | | | | | |
| Aqueous solution of urethane resin | | | | | |
| Acetylenol E00 | 0.10 | 0.10 | 0.10 | 0.10 | 0.10 |
| NIKKOL BL-9EX | | | | | |
| Acetylenol E200 | | | | | |
| Acetylenol E100 | | | | | |
| Acetylenol E60 | | | | | |
| Uniox G-1200 | | | | | |
| KF-6012 | | | | | |
| Ion-exchange water | 49.90 | 49.90 | 49.90 | 49.90 | 49.90 |
| Pigment content P (%) | 3.00 | 3.00 | 3.00 | 3.00 | 3.00 |
| Content S of water-soluble organic | 20.00 | 20.00 | 20.00 | 20.00 | 20.00 |
| solvent (%) | | | | | |
| Content S₁ of first water-soluble | 10.00 | 10.00 | 10.00 | 10.00 | 10.00 |
| organic solvent (%) | | | | | |
| Content S₂ of second water-soluble | 10.00 | 10.00 | 10.00 | 10.00 | 10.00 |
| organic solvent (%) | | | | | |
| Value of S/P (times) | 3.3 | 3.3 | 3.3 | 3.3 | 3.3 |
| Average relative dielectric constant of | 32.5 | 32.5 | 32.5 | 32.5 | 32.5 |
| water-soluble organic solvent | | | | | |
| (S₁/S) · 100 (%) | 50.0 | 50.0 | 50.0 | 50.0 | 50.0 |
| (S₂/S) · 100 (%) | 50.0 | 50.0 | 50.0 | 50.0 | 50.0 |
| Viscosity η₀ of Ink (mN/m) | 2.2 | 2.5 | 2.6 | 2.5 | 2.3 |
| Viscosity η₄₀ of evaporated ink | 4.0 | 17.1 | 18.2 | 17.5 | 16.2 |
| (mN/m) | | | | | |
| Value of η₄₀/η₀ (times) | 1.8 | 6.8 | 7.0 | 7.0 | 7.0 |
| Surface tension γ of ink (mN/m) | 37 | 37 | 37 | 37 | 37 |

TABLE 2-7
Composition and characteristics of ink

| | Ink | | | | |
|---|---|---|---|---|---|
| | 31 | 32 | 33 | 34 | 35 |
| Kind of pigment dispersion liquid | 13 | 14 | 15 | 1 | 1 |
| Pigment dispersion liquid | 30.00 | 30.00 | 30.00 | 30.00 | 30.00 |
| C.I. Direct Black 195 | | | | | |
| Glycerin (42.7) | 10.00 | 10.00 | 10.00 | 10.00 | 10.00 |
| 1,5-Pentanediol (27.0) | | | | | |
| Triethylene glycol (22.3) | 10.00 | 10.00 | 10.00 | 10.00 | 10.00 |
| 1,6-Hexanediol (7.1) | | | | | |
| Aqueous solution of urethane resin | | | | | |
| Acetylenol E00 | 0.10 | 0.10 | 0.10 | 0.08 | 0.12 |
| NIKKOL BL-9EX | | | | | |
| Acetylenol E200 | | | | | |
| Acetylenol E100 | | | | | |
| Acetylenol E60 | | | | | |
| Uniox G-1200 | | | | | |
| KF-6012 | | | | | |
| Ion-exchange water | 49.90 | 49.90 | 49.90 | 49.92 | 49.88 |
| Pigment content P (%) | 3.00 | 3.00 | 3.00 | 3.00 | 3.00 |
| Content S of water-soluble organic | 20.00 | 20.00 | 20.00 | 20.00 | 20.00 |
| solvent (%) | | | | | |
| Content S₁ of first water-soluble | 10.00 | 10.00 | 10.00 | 10.00 | 10.00 |
| organic solvent (%) | | | | | |
| Content S₂ of second water-soluble | 10.00 | 10.00 | 10.00 | 10.00 | 10.00 |
| organic solvent (%) | | | | | |
| Value of S/P (times) | 3.3 | 3.3 | 3.3 | 3.3 | 3.3 |
| Average relative dielectric constant of | 32.5 | 32.5 | 32.5 | 32.5 | 32.5 |
| water-soluble organic solvent | | | | | |
| (S₁/S) · 100 (%) | 50.0 | 50.0 | 50.0 | 50.0 | 50.0 |
| (S₂/S) · 100 (%) | 50.0 | 50.0 | 50.0 | 50.0 | 50.0 |
| Viscosity η₀ of Ink (mN/m) | 2.2 | 2.2 | 2.2 | 2.2 | 2.2 |
| Viscosity η₄₀ of evaporated ink | 4.0 | 12.9 | 15.1 | 4.0 | 4.0 |
| (mN/m) | | | | | |
| Value of η₄₀/η₀ (times) | 1.8 | 5.9 | 6.9 | 1.8 | 1.8 |
| Surface tension γ of ink (mN/m) | 37 | 37 | 37 | 38 | 34 |

TABLE 2-8
Composition and characteristics of ink

| | Ink | | | | |
|---|---|---|---|---|---|
| | 36 | 37 | 38 | 39 | 40 |
| Kind of pigment dispersion liquid | 1 | 1 | 1 | 1 | 1 |
| Pigment dispersion liquid | 45.00 | 40.00 | 30.00 | 30.00 | 30.00 |
| C.I. Direct Black 195 | | | | | |
| Glycerin (42.7) | 10.00 | 10.00 | 10.00 | 10.00 | 10.00 |
| 1,5-Pentanediol (27.0) | | | | | |
| Triethylene glycol (22.3) | 10.00 | 10.00 | 10.00 | 10.00 | 10.00 |
| 1,6-Hexanediol (7.1) | | | | | |
| Aqueous solution of urethane resin | 4.00 | 2.00 | | | |
| Acetylenol E00 | 0.12 | 0.10 | 0.10 | 0.10 | 0.10 |
| NIKKOL BL-9EX | | | | | |
| Acetylenol E200 | | | | | |
| Acetylenol E100 | | | | | |
| Acetylenol E60 | | | | | |
| Uniox G-1200 | | | | | |
| KF-6012 | | | 0.50 | 0.40 | 0.30 |
| Ion-exchange water | 30.88 | 37.90 | 49.40 | 49.50 | 49.60 |
| Pigment content P (%) | 4.50 | 4.00 | 3.00 | 3.00 | 3.00 |
| Content S of water-soluble organic | 20.00 | 20.00 | 20.00 | 20.00 | 20.00 |
| solvent (%) | | | | | |
| Content S₁ of first water-soluble | 10.00 | 10.00 | 10.00 | 10.00 | 10.00 |
| organic solvent (%) | | | | | |
| Content S₂ of second water-soluble | 10.00 | 10.00 | 10.00 | 10.00 | 10.00 |
| organic solvent (%) | | | | | |
| Value of S/P (times) | 2.2 | 2.5 | 3.3 | 3.3 | 3.3 |
| Average relative dielectric constant of | 32.5 | 32.5 | 32.5 | 32.5 | 32.5 |
| water-soluble organic solvent | | | | | |
| (S₁/S) · 100 (%) | 50.0 | 50.0 | 50.0 | 50.0 | 50.0 |
| (S₂/S) · 100 (%) | 50.0 | 50.0 | 50.0 | 50.0 | 50.0 |
| Viscosity η₀ of Ink (mN/m) | 4.1 | 3.7 | 2.2 | 2.2 | 2.2 |
| Viscosity η₄₀ of evaporated ink | 32.0 | 20.0 | 4.0 | 4.0 | 4.0 |
| (mN/m) | | | | | |
| Value of η₄₀/η₀ (times) | 7.8 | 5.4 | 1.8 | 1.8 | 1.8 |
| Surface tension γ of ink (mN/m) | 37 | 37 | 25 | 26 | 30 |

TABLE 2-9
Composition and characteristics of ink

| | Ink | | | | |
|---|---|---|---|---|---|
| | 41 | 42 | 43 | 44 | 45 |
| Kind of pigment dispersion liquid | 1 | 1 | 16 | 1 | — |
| Pigment dispersion liquid | 30.00 | 30.00 | 50.00 | 30.00 | |
| C.I. Direct Black 195 | | | | | 3.00 |
| Glycerin (42.7) | 10.00 | 10.00 | 6.50 | 7.00 | 7.00 |
| 1,5-Pentanediol (27.0) | | | | | |
| Triethylene glycol (22.3) | 10.00 | 10.00 | 13.50 | 6.00 | 6.00 |
| 1,6-Hexanediol (7.1) | | | | 7.00 | 7.00 |
| Aqueous solution of urethane resin | | | 2.00 | | |
| Acetylenol E00 | | | | 0.10 | 0.10 |
| NIKKOL BL-9EX | | | 0.03 | | |
| Acetylenol E200 | | | | | |
| Acetylenol E100 | 0.05 | 0.03 | | | |
| Acetylenol E60 | | | | | |
| Uniox G-1200 | 0.50 | 0.50 | | | |
| KF-6012 | | | | | |
| Ion-exchange water | 49.45 | 49.47 | 27.97 | 49.90 | 76.90 |
| Pigment content P (%) | 3.00 | 3.00 | 5.00 | 3.00 | 0.00 |
| Content S of water-soluble organic | 20.00 | 20.00 | 20.00 | 20.00 | 20.00 |
| solvent (%) | | | | | |
| Content S₁ of first water-soluble | 10.00 | 10.00 | 6.50 | 7.00 | 7.00 |
| organic solvent (%) | | | | | |
| Content S₂ of second water-soluble | 10.00 | 10.00 | 6.50 | 7.00 | 7.00 |
| organic solvent (%) | | | | | |
| Value of S/P (times) | 3.3 | 3.3 | 1.3 | 2.3 | — |
| Average relative dielectric constant of | 32.5 | 32.5 | 28.9 | 24.1 | 24.1 |
| water-soluble organic solvent | | | | | |
| (S₁/S) · 100 (%) | 50.0 | 50.0 | 32.5 | 35.0 | 35.0 |
| (S₂/S) · 100 (%) | 50.0 | 50.0 | 32.5 | 35.0 | 35.0 |
| Viscosity η₀ of Ink (mN/m) | 2.2 | 2.2 | 4.2 | 2.2 | 2.1 |
| Viscosity η₄₀ of evaporated ink | 4.2 | 4.2 | 35.0 | 4.3 | 3.8 |
| (mN/m) | | | | | |
| Value of η₄₀/η₀ (times) | 1.9 | 1.9 | 8.3 | 2.0 | 1.8 |
| Surface tension γ of ink (mN/m) | 44 | 46 | 37 | 37 | 37 |

### <Production of Recording Unit>

A recording head employing a system of ejecting ink by applying thermal energy was prepared. A recording element substrate for forming the recording head has arranged therein an ejection orifice array formed by arraying 416 ejection orifices at an array density of 600 dpi and an array length L_{N} (mm) shown in Table 3. The mass of an ink droplet ejected from one ejection orifice is 9.0 ng. In addition, thermoplastic resin compositions were molded to provide ink storage portions having inner sizes shown in Table 3. As the thermoplastic resin composition, there was used a thermoplastic resin composition obtained by adding, as the filler material, 25 parts of E-glass chopped strand having a length of 5 mm to 100 parts of a thermoplastic resin, which was a mixture of a styrene-based resin and polyphenylene ether. Further, a plurality of kinds of ink absorbents having different bulk densities ρ_{b} were prepared. Then, each of the ink absorbents was stored in the resultant ink storage portion, and the recording head was attached thereto without intermediation of any other member. Thus, recording units 1 to 24 were produced. Recording unit 25 was configured such that no ink absorbent was provided inside it. The characteristics of the produced recording units are shown in Table 3. The bulk density of each of the ink absorbents was calculated by measuring the volume thereof as a form stored in the ink storage portion and dividing the mass thereof by the volume.

TABLE 3
Characteristics of recording unit

| | | | | | | | | | Relationship |
|---|---|---|---|---|---|---|---|---|---|
| | | | | | | | | | between |
| | | | | | | | | | center |
| | | | | | | | | | position of |
| | | | | | | | | | ejection |
| | | | | | | | Array | | orifice |
| | Inner size | | | | | | length | | array |
| | of ink | | | | | Bulk | L_{N} of | | and center |
| | storage | | | Value | Value | density ρ_{b} | ejection | Value | position |
| | portion | | | of | of | of ink | orifice | of | of ink |
| Recording | X | Y | Z | Y/X | Z/X | absorbent | array | L_{N}/Y | storage |
| unit | (mm) | (mm) | (mm) | (times) | (times) | (g/cm³) | (mm) | (times) | portion |
| 1 | 20 | 60 | 40 | 3.0 | 2.0 | 0.07 | 20 | 0.33 | Offset |
| 2 | 20 | 48 | 40 | 2.4 | 2.0 | 0.07 | 20 | 0.42 | Offset |
| 3 | 20 | 80 | 40 | 4.0 | 2.0 | 0.07 | 20 | 0.25 | Offset |
| 4 | 20 | 60 | 60 | 3.0 | 3.0 | 0.07 | 20 | 0.33 | Offset |
| 5 | 20 | 60 | 40 | 3.0 | 2.0 | 0.05 | 20 | 0.33 | Offset |
| 6 | 20 | 60 | 40 | 3.0 | 2.0 | 0.04 | 20 | 0.33 | Offset |
| 7 | 20 | 60 | 40 | 3.0 | 2.0 | 0.12 | 20 | 0.33 | Offset |
| 8 | 20 | 60 | 40 | 3.0 | 2.0 | 0.13 | 20 | 0.33 | Offset |
| 9 | 20 | 60 | 40 | 3.0 | 2.0 | 0.10 | 20 | 0.33 | Offset |
| 10 | 20 | 60 | 40 | 3.0 | 2.0 | 0.049 | 20 | 0.33 | Offset |
| 11 | 20 | 60 | 21 | 3.0 | 1.05 | 0.07 | 20 | 0.33 | Offset |
| 12 | 20 | 60 | 22 | 3.0 | 1.10 | 0.07 | 20 | 0.33 | Offset |
| 13 | 20 | 60 | 40 | 3.0 | 2.0 | 0.07 | 6 | 0.10 | Offset |
| 14 | 20 | 60 | 40 | 3.0 | 2.0 | 0.07 | 48 | 0.80 | Offset |
| 15 | 20 | 60 | 40 | 3.0 | 2.0 | 0.07 | 55 | 0.92 | Offset |
| 16 | 20 | 60 | 40 | 3.0 | 2.0 | 0.07 | 20 | 0.33 | Match |
| 17 | 20 | 80 | 60 | 4.0 | 3.0 | 0.15 | 20 | 0.25 | Offset |
| 18 | 20 | 90 | 40 | 4.5 | 2.0 | 0.07 | 20 | 0.22 | Offset |
| 19 | 20 | 60 | 80 | 3.0 | 4.0 | 0.07 | 20 | 0.33 | Offset |
| 20 | 20 | 60 | 80 | 3.0 | 4.0 | 0.07 | 48 | 0.80 | Offset |
| 21 | 20 | 60 | 80 | 3.0 | 4.0 | 0.07 | 55 | 0.92 | Offset |
| 22 | 20 | 90 | 40 | 4.5 | 2.0 | 0.07 | 20 | 0.22 | Match |
| 23 | 20 | 45 | 40 | 2.3 | 2.0 | 0.07 | 20 | 0.44 | Offset |
| 24 | 20 | 60 | 20 | 3.0 | 1.0 | 0.07 | 20 | 0.33 | Offset |
| 25 | 20 | 60 | 40 | 3.0 | 2.0 | — | 20 | 0.33 | Offset |

### <Evaluation>

An ink jet recording apparatus (product name: “PIXUS TS6630”, manufactured by CANON KABUSHIKI KAISHA) was prepared and reconstructed so as to incorporate each of the recording units produced above. At the time of an evaluation, a suction pump included in the main body of the ink jet recording apparatus was not used in the suction operation of an ejection orifice, and a recovery operation was performed only by preliminary ejection and the wiping of an ejection orifice surface. The resolution of the ink jet recording apparatus is 600 dpi×600 dpi. In addition, such a condition that two ink droplets each having a mass per droplet of 9 ng±10% are applied to a unit region measuring 1/600 inch by 1/600 inch is defined as “recording duty is 100%.” In the present disclosure, in the following evaluation criteria, the levels “S”, “AAA”, “AA”, “A” and “B” were regarded as acceptable levels, and the levels “C” and “D” were regarded as unacceptable levels. The evaluation results are shown in Table 4 (Table 4-1 to Table 4-3).

### (Density Unevenness)

20 Grams of the ink whose kind was shown in Table 4 was loaded into the ink storage portion of the recording unit whose kind was shown in Table 4, and a protective tape having an adhesive layer was attached to the ejection orifice surface thereof, followed by the sealing of the unit in a sealed container. Under the state, the recording unit was stored in a temperature-controlled chamber at 60° C. for 2 months while the ejection orifice surface was directed downward in the direction of gravity. After the protective tape of the recording unit removed from the sealed container had been peeled off, the unit was mounted on the ink jet recording apparatus under an environment at a temperature of 30° C. and a relative humidity of 10%, and a suction operation of discharging about 0.3 g of the ink by preliminary ejection was performed twice. After the lapse of 2 minutes from the completion of the suction operation, a solid image having a recording duty of 25% was repeatedly recorded on the entire surface of a recording medium. A4 size plain paper (product name: “CS-680”, manufactured by CANON KABUSHIKI KAISHA) was used as the recording medium. At this time, the recording was performed by a single-pass method in which the ink was applied to a unit region (for one band) corresponding to the width of the array length L_{N} (mm) of the ejection orifice array shown in Table 3 by one main scan of the recording head. When the density unevenness of the image occurred and was not eliminated, the recording was paused for 2 minutes, and then the solid image was further recorded on one sheet of the recording medium, followed by the repetition of the cycle until the density unevenness of the image was eliminated. The presence or absence of the density unevenness of the image was visually observed. The density unevenness of the image was evaluated by using the cumulative number of recording passes until the density unevenness of the image was eliminated as an index in accordance with the following evaluation criteria.
S: No density unevenness was observed from the start of the recording of the first pass.
AAA: The number of recording passes until the density unevenness was eliminated was 2 or more to 15 or less.
AA: The number of recording passes until the density unevenness was eliminated was more than 15 to 45 or less.
A: The number of recording passes until the density unevenness was eliminated was more than 45 to 120 or less.
B: The number of recording passes until the density unevenness was eliminated was more than 120 to 200 or less.
C: The number of recording passes until the density unevenness was eliminated was more than 200 to 400 or less.
D: The density unevenness was observed even after the number of recording passes had exceeded 400 passes.

TABLE 4-1
Evaluation conditions and evaluation results

| | | Evaluation condition | | | | | Evaluation |
|---|---|---|---|---|---|---|---|
| | | | | | Value | Value | result |
| | | | Recording | Suction | of | of | Density |
| | | Ink | unit | pump | ρ_{b} × η₄₀ | ρ_{b} × γ | unevenness |
| Example | 1 | 1 | 1 | Absent | 0.3 | 2.6 | S |
| | 2 | 2 | 1 | Absent | 0.2 | 2.6 | S |
| | 3 | 3 | 1 | Absent | 0.3 | 2.6 | S |
| | 4 | 1 | 2 | Absent | 0.3 | 2.6 | S |
| | 5 | 1 | 3 | Absent | 0.3 | 2.6 | S |
| | 6 | 1 | 4 | Absent | 0.3 | 2.6 | S |
| | 7 | 4 | 1 | Absent | 0.3 | 2.6 | S |
| | 8 | 5 | 1 | Absent | 0.3 | 2.6 | S |
| | 9 | 6 | 1 | Absent | 0.3 | 2.7 | AA |
| | 10 | 7 | 1 | Absent | 0.3 | 2.7 | AAA |
| | 11 | 8 | 1 | Absent | 0.3 | 2.7 | S |
| | 12 | 9 | 1 | Absent | 0.3 | 2.6 | S |
| | 13 | 10 | 1 | Absent | 0.3 | 2.6 | S |
| | 14 | 11 | 1 | Absent | 0.3 | 2.2 | B |
| | 15 | 12 | 1 | Absent | 0.3 | 3.6 | A |
| | 16 | 13 | 1 | Absent | 0.3 | 2.6 | AA |
| | 17 | 14 | 1 | Absent | 0.3 | 2.4 | AAA |
| | 18 | 15 | 1 | Absent | 0.3 | 3.6 | S |
| | 19 | 16 | 1 | Absent | 0.3 | 2.5 | S |
| | 20 | 17 | 1 | Absent | 0.2 | 2.7 | AAA |

TABLE 4-2
Evaluation conditions and evaluation results

| | | Evaluation condition | | | | | Evaluation |
|---|---|---|---|---|---|---|---|
| | | | | | Value | Value | result |
| | | | Recording | Suction | of | of | Density |
| | | Ink | unit | pump | ρ_{b} × η₄₀ | ρ_{b} × γ | unevenness |
| Example | 21 | 18 | 1 | Absent | 0.2 | 2.7 | S |
| | 22 | 19 | 1 | Absent | 2.0 | 2.6 | AAA |
| | 23 | 20 | 5 | Absent | 1.5 | 1.9 | AAA |
| | 24 | 21 | 5 | Absent | 1.8 | 1.9 | AA |
| | 25 | 22 | 1 | Absent | 1.3 | 2.6 | AAA |
| | 26 | 23 | 1 | Absent | 1.1 | 2.6 | S |
| | 27 | 24 | 1 | Absent | 0.3 | 2.6 | S |
| | 28 | 25 | 1 | Absent | 0.3 | 2.6 | AAA |
| | 29 | 26 | 1 | Absent | 0.3 | 2.6 | AAA |
| | 30 | 27 | 1 | Absent | 1.2 | 2.6 | AAA |
| | 31 | 28 | 1 | Absent | 1.3 | 2.6 | AAA |
| | 32 | 29 | 1 | Absent | 1.2 | 2.6 | AAA |
| | 33 | 30 | 1 | Absent | 1.1 | 2.6 | AAA |
| | 34 | 31 | 1 | Absent | 0.3 | 2.6 | S |
| | 35 | 32 | 1 | Absent | 0.9 | 2.6 | S |
| | 36 | 33 | 1 | Absent | 1.1 | 2.6 | AAA |
| | 37 | 34 | 6 | Absent | 0.2 | 1.5 | AAA |
| | 38 | 34 | 5 | Absent | 0.2 | 1.9 | S |
| | 39 | 35 | 7 | Absent | 0.5 | 4.1 | S |
| | 40 | 35 | 8 | Absent | 0.5 | 4.4 | AAA |

TABLE 4-3
Evaluation conditions and evaluation results

| | | Evaluation condition | | | | | Evaluation |
|---|---|---|---|---|---|---|---|
| | | | | | Value | Value | result |
| | | | Recording | Suction | of | of | Density |
| | | Ink | unit | pump | ρ_{b} × η₄₀ | ρ_{b} × γ | unevenness |
| Example | 41 | 19 | 7 | Absent | 3.2 | 4.4 | AAA |
| | 42 | 36 | 7 | Absent | 3.8 | 4.4 | A |
| | 43 | 37 | 9 | Absent | 2.0 | 3.7 | S |
| | 44 | 38 | 10 | Absent | 0.2 | 1.2 | AA |
| | 45 | 39 | 5 | Absent | 0.2 | 1.3 | S |
| | 46 | 40 | 5 | Absent | 0.2 | 1.5 | S |
| | 47 | 1 | 7 | Absent | 0.5 | 4.4 | S |
| | 48 | 41 | 7 | Absent | 0.5 | 5.3 | AAA |
| | 49 | 42 | 7 | Absent | 0.5 | 5.5 | AA |
| | 50 | 1 | 11 | Absent | 0.3 | 2.6 | AAA |
| | 51 | 1 | 12 | Absent | 0.3 | 2.6 | S |
| | 52 | 1 | 13 | Absent | 0.3 | 2.6 | S |
| | 53 | 1 | 14 | Absent | 0.3 | 2.6 | S |
| | 54 | 1 | 15 | Absent | 0.3 | 2.6 | S |
| | 55 | 1 | 16 | Absent | 0.3 | 2.6 | S |
| | 56 | 43 | 17 | Absent | 5.3 | 5.6 | B |
| Comparative | 1 | 1 | 18 | Absent | 0.3 | 2.6 | D |
| Example | 2 | 1 | 19 | Absent | 0.3 | 2.6 | C |
| | 3 | 44 | 1 | Absent | 0.3 | 2.6 | C |
| | 4 | 1 | 20 | Absent | 0.3 | 2.6 | D |
| | 5 | 1 | 21 | Absent | 0.3 | 2.6 | C |
| | 6 | 1 | 22 | Absent | 0.3 | 2.6 | C |
| Reference | 1 | 1 | 23 | Absent | 0.3 | 2.6 | S |
| Example | 2 | 1 | 24 | Absent | 0.3 | 2.6 | S |
| | 3 | 1 | 1 | Present | 0.3 | 2.6 | S |
| | 4 | 44 | 1 | Present | 0.3 | 2.6 | S |
| | 5 | 45 | 1 | Present | 0.3 | 2.6 | S |
| | 6 | 1 | 25 | Present | — | — | S |

The ink disposability of the recording unit used in Example 54 was lower than that of any other Example. The recording unit used in Reference Example 1 and 2 had an ink storage amount smaller than that of any other example.

According to the present disclosure, the problem that occurs when a recording apparatus, the apparatus including an ink storage portion in which an ink storage amount is sufficiently secured, but being free of a suction mechanism for sucking aqueous ink in a recording head through an ejection orifice, is used can be solved. That is, there can be provided an ink jet recording method capable of recording, when such recording apparatus is used, an image in which density unevenness is unlikely to occur even after the recording apparatus has been left for a long time period under a state of storing the aqueous ink. In addition, according to the present disclosure, there can be provided an ink jet recording apparatus to be used in the ink jet recording method.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-018613, filed Feb. 6, 2025, and Japanese Patent Application No. 2026-008334, filed Jan. 21, 2026, which are hereby incorporated by reference herein in their entirety.

What is claimed is:

1. An ink jet recording method comprising recording an image by applying aqueous ink ejected from an ejection orifice to a recording medium through use of an ink jet recording apparatus, the ink jet recording apparatus comprising:
the aqueous ink;
an ink storage portion configured to store the aqueous ink; and
a recording head having an ejection orifice surface, which is attached to the ink storage portion and on which the ejection orifice configured to eject the aqueous ink supplied from the ink storage portion is formed,
the ink jet recording apparatus being free of a suction mechanism configured to suck the aqueous ink in the recording head through the ejection orifice,
wherein, when a direction of reciprocating movement of the recording head is defined as an X-axis direction, a direction substantially perpendicular to the direction of the reciprocating movement of the recording head is defined as a Y-axis direction, and a direction of gravity is defined as a Z-axis direction, an inner size X (mm) of the ink storage portion in the X-axis direction, an inner size Y (mm) thereof in the Y-axis direction and an inner size Z (mm) thereof in the Z-axis direction satisfy relationships of the following formulae (1) and (2),
wherein the aqueous ink comprises a pigment and a water-soluble organic solvent, and
wherein an average relative dielectric constant of the water-soluble organic solvent is 25.0 or more:
$$2.4 X \leq Y \leq 4. X \qquad ( 1 )$$
$$1. X < Z \leq 3. X . \qquad ( 2 )$$

2. The ink jet recording method according to claim 1, wherein a ratio of a content (% by mass) of a water-soluble organic solvent having a relative dielectric constant of 25.0 or more to a total content (% by mass) of the water-soluble organic solvents in the aqueous ink is 35.0% by mass or more.

3. The ink jet recording method according to claim 1, wherein a ratio of a content (% by mass) of a water-soluble organic solvent having a relative dielectric constant of 35.0 or more to a total content (% by mass) of the water-soluble organic solvents in the aqueous ink is 35.0% by mass or more.

4. The ink jet recording method according to claim 1, wherein the aqueous ink further comprises a nonionic surfactant, and the nonionic surfactant comprises a compound represented by the following general formula (A): 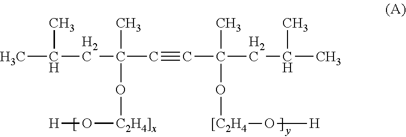
in the general formula (A), “x” and “y” each independently represent an integer of 0 or more.

5. The ink jet recording method according to claim 4, wherein an HLB value of the nonionic surfactant is 14 or less.

6. The ink jet recording method according to claim 4, wherein an HLB value of the nonionic surfactant is 11 or less.

7. The ink jet recording method according to claim 4, wherein an HLB value of the nonionic surfactant is 0.

8. The ink jet recording method according to claim 1, wherein the aqueous ink further comprises a nonionic surfactant and the nonionic surfactant comprises a compound represented by the following general formula (B): 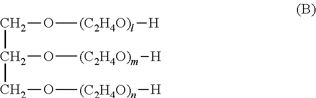
in the general formula (B), “l”, “m” and “n” each independently represent an integer of 0 or more, and l+m+n is 1 or more.

9. The ink jet recording method according to claim 1,
wherein a viscosity η₀ of the aqueous ink is 1.7 mPa·s or more to 4.0 mPa·s or less, and
wherein the viscosity η₀ (mPa·s) of the aqueous ink and a viscosity η₄₀ (mPa·s) of evaporated ink, which is obtained by evaporating 40% by mass of the aqueous ink, satisfy a relationship of the following formula (3):
$${η}_{40} \leq 7.1 {η}_{0} . \qquad ( 3 )$$

10. The ink jet recording method according to claim 1, wherein a cumulative 50% particle diameter in a volume-based particle size distribution of the pigment is 40 nm or more to 220 nm or less.

11. The ink jet recording method according to claim 1, wherein the pigment is a self-dispersible pigment in which an anionic group is bonded to a particle surface thereof directly or via another atomic group.

12. The ink jet recording method according to claim 11, wherein an anionic group amount of the self-dispersible pigment is 0.08 mmol/g or more to 0.30 mmol/g or less.

13. The ink jet recording method according to claim 1,
wherein the ink storage portion internally comprises an ink absorbent configured to hold the aqueous ink, and
wherein a bulk density ρ_{b} of the ink absorbent is 0.05 g/cm³ or more to 0.12 g/cm³ or less.

14. The ink jet recording method according to claim 13, wherein the bulk density ρ_{b} (g/cm³) of the ink absorbent and a viscosity η₄₀ (mPa·s) of evaporated ink, which is obtained by evaporating 40% by mass of the aqueous ink, satisfy a relationship of the following formula (4):
$${ρ}_{{b}^{\times }} {η}_{40} \leq 3.4 . \qquad ( 4 )$$

15. The ink jet recording method according to claim 13, wherein the bulk density ρ_{b} (g/cm³) of the ink absorbent and a viscosity η₄₀ (mPa·s) of evaporated ink, which is obtained by evaporating 40% by mass of the aqueous ink, satisfy a relationship of the following formula (5):
$${ρ}_{{b}^{\times }} {η}_{40} \leq 2. . \qquad ( 5 )$$

16. The ink jet recording method according to claim 13, wherein the bulk density ρ_{b} (g/cm³) of the ink absorbent and a surface tension γ (mN/m) of the aqueous ink satisfy a relationship of the following formula (6):
$$1.3 \leq {ρ}_{{b}^{\times }} γ \leq 5.4 . \qquad ( 6 )$$

17. The ink jet recording method according to claim 13, wherein the bulk density ρ_{b} (g/cm³) of the ink absorbent and a surface tension γ (mN/m) of the aqueous ink satisfy a relationship of the following formula (7):
$$1.5 \leq {ρ}_{{b}^{\times }} γ \leq 4.4 . \qquad ( 7 )$$

18. The ink jet recording method according to claim 1, wherein the inner size X (mm) and the inner size Z (mm) of the ink storage portion satisfy a relationship of the following formula (8):
$$1.1 X \leq Z \leq 3. X . \qquad ( 8 )$$

19. The ink jet recording method according to claim 1,
wherein an ejection orifice array in which a plurality of the ejection orifices are arrayed is formed on the ejection orifice surface of the recording head, and
wherein a ratio (L_{N}/Y) of an array length L_{N} (mm) of the ejection orifice array to the inner size Y (mm) of the ink storage portion is 0.80 times or less.

20. The ink jet recording method according to claim 19, wherein a center position of the ejection orifice array in the Y-axis direction and a center position of the ink storage portion in the Y-axis direction are arranged to be shifted from each other.

21. An ink jet recording apparatus comprising:
aqueous ink;
an ink storage portion configured to store the aqueous ink; and
a recording head having an ejection orifice surface, which is attached to the ink storage portion and on which an ejection orifice configured to eject the aqueous ink supplied from the ink storage portion are formed,
the ink jet recording apparatus being free of a suction mechanism configured to suck the aqueous ink in the recording head through the ejection orifice,
wherein, when a direction of reciprocating movement of the recording head is defined as an X-axis direction, a direction substantially perpendicular to the direction of the reciprocating movement of the recording head is defined as a Y-axis direction, and a direction of gravity is defined as a Z-axis direction, an inner size X (mm) of the ink storage portion in the X-axis direction, an inner size Y (mm) thereof in the Y-axis direction and an inner size Z (mm) thereof in the Z-axis direction satisfy relationships of the following formulae (1) and (2),
wherein the aqueous ink comprises a pigment and a water-soluble organic solvent, and
wherein an average relative dielectric constant of the water-soluble organic solvent is 25.0 or more:
$$2.4 X \leq Y \leq 4. X \qquad ( 1 )$$
$$1. X < Z \leq 3. X . \qquad ( 2 )$$
